(19) United States
(12) Patent Application Publication
(10) Pub. No.: US 2007/0151584 A1
(43) Pub. Date: Jul. 5, 2007

(54) Dishwasher

(75) Inventors: Masanori Omachi, Otsu-shi (JP); Masakatsu Morishige, Otsu-shi (JP); Hideyuki Nito, Otsu-shi (JP); Mitsunori Shinmura, Moriyama-shi (JP); Hajime Suzuki, Otsu-shi (JP); Kiyoyuki Suo, Kusatsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD

(21) Appl. No.: 10/556,686

(22) PCT Filed: Apr. 15, 2004
(86) PCT No.: PCT/JP04/05437

§ 371 Date: Oct. 2, 2006

(30) Foreign Application Priority Data
May 16, 2003 (JP) 2003-138907

(51) Int. Cl. B08B 3/00

(52) U.S. Cl. 134/56 D; 134/198; 134/57 D

(57) ABSTRACT

The dishwasher according to the present invention has two operation courses: one course adapted for using a low-foaming dedicated detergent; and the other course adapted for using a high-foaming kitchen detergent. In the kitchen detergent course, the dishwashing operation includes a first mode of the “spray and wait” process carried out as a preliminary washing operation, including the steps of spraying the water containing a detergent onto the dishes for a short period of time and subsequently halting the spray for a certain period of time. During this process, the amount of the foam present within the wash chamber is determined by means of a photosensor located within the drying duct. If there is a large amount of foam, a longer period of time is set for draining the detergent water. After the water is drained for the aforementioned period of time, fresh water is supplied to a predetermined level. With the concentration of the detergent water thus regulated, a second mode of the “spray and wait” process is carried out as the main washing operation. For a larger amount of the foam produced in the first “spray and wait” process, the detergent water is diluted to have a smaller concentration, so that the second “spray and wait” process is prevented from producing an abnormally large amount of foam. Thus, the dishwasher is capable of washing the dishes with an inexpensive, easy-to-purchase kitchen detergent while preventing the foam from escaping to the outside.

### TECHNICAL FIELD

The present invention relates to a dishwasher for washing dishes and/or utensils by spraying water onto the dishes and utensils contained in a wash chamber. In the present description, the word “dishes” should be interpreted as the “dishes and/or utensils,” if not otherwise specified.

### BACKGROUND ART

In general, a household dishwasher for washing and rinsing the dishes includes a wash chamber for containing the dishes, a water supply for introducing water into the wash chamber, and a pump for drawing water from the bottom of the wash chamber into a wash arm and for spraying the water from the nozzles of the wash arm onto the dishes. The sprayed water hits the dishes or the inner wall of the wash chamber, and then returns to the bottom of the wash chamber and passes through a filter for removing food particles. The filtered water is drawn again by the pump.

In such a dishwasher, if a common kitchen detergent (which is simply called the “kitchen detergent” hereinafter) is used, an abnormal amount of foam develops during the washing operation. This is simply because kitchen detergents are easy to foam. This situation deteriorates the washing performance and often allows the foam to leak through the inlet port or the exhaust port for the drying air. Accordingly, users of dishwashers are instructed to use a dishwasher-dedicated detergent (which is simply the “dedicated detergent” hereinafter), which is designed to foam only a little.

In most of the households using dishwashers, the user has both a dedicated detergent and a kitchen detergent. Therefore, it is naturally possible that the user mistakenly uses the kitchen detergent when he or she uses the dishwasher to wash the dishes. To avoid this problem, conventional dishwashers, such as disclosed in the Japanese Unexamined Patent Publication No. 2002-336175, include a means for detecting an abnormal development of the foam. If the abnormal foaming is detected, the dishwasher stops the operation and informs the user of the trouble.

However, users still desire to have a new type of dishwasher that allows the use of kitchen detergents because: to use different detergents for different washing methods is troublesome; kitchen detergents circulate in much larger quantities and are less expensive; and the detergent, water and electric power are wasted if a wrong type of detergent is used.

Many problems must be solved to enable a dishwasher to accept kitchen detergents. Some of the major problems are listed below:

(1) As explained earlier, conventional dishwashers need a foam detector for detecting an abnormal amount of foam within the wash chamber that will develop if a kitchen detergent is used. A typical foam detector is disclosed in the Japanese Unexamined Patent Publication No. 2003-47584, which detects an electric current that flows between a pair of electrodes if the foam fills the space between them. This detector, however, has the problem that it cannot detect the foam until the space between the electrodes is completely filled with the foam. This may delay the detection of the foam, or at worst fail to detect it although a large amount of foam is present. Moreover, the detection of the foam requires the detergent water to have an adequate electrical conductivity. Therefore, it may be unable to correctly detect the foam produced from a certain kind of detergent.

(2) If a large amount of foam is present within the wash chamber, it is necessary to extinguish the foam (i.e. “defoam”) to resume the operation. After the defoaming process, the operation should keep the amount of the foam as small as possible, because an immediate reoccurrence of the foam will badly deteriorate the operational efficiency.

(3) It is necessary to take a measure that prevents the foam (or the detergent water) from leaking to the outside even when a large amount of foam is produced within the wash chamber.

(4) The foam produced from a kitchen detergent has the effect of getting stains to separate from the dishes and preventing the stains from sticking to the dishes again. Therefore, if the dishwasher is operated so that the foaming is suppressed, it will be difficult to attain an adequate level of washing performance. However, the performance should not be far lower than that obtained in the case where a dedicated detergent is used. Preferably, the performance should be as high as that attained using a dedicated detergent.

(5) Many users desire to usually use a dedicated detergent to obtain a high level of washing performance and sometimes switch to a kitchen detergent, thus selectively using the two types of detergents according to the situation. However, it will be troublesome for users to make necessary settings on the dishwasher according to the type of detergent used. It should be also taken into account that the user may select one type of detergent on the dishwasher and put another type into the dishwasher.

### DISCLOSURE OF THE INVENTION

To solve the above-described problems, the present invention intends to provide a dishwasher capable of exhibiting a high level of washing and rinsing performance even when a common kitchen detergent is used.

Thus, the present invention provides a dishwasher having a wash chamber for containing the dishes and a washing means for drawing water from the bottom of the wash chamber and for spraying the water onto the dishes, which is characterized by:

a detergent selector for determining whether the detergent used is a dishwasher-dedicated detergent or a common kitchen detergent and for setting the detergent type, or for allowing users to externally set the detergent type, before the start of or in the initial phase of the operation; and

an operation controller for selectively carrying out one of the following operational sequences according to the detergent type set by the detergent selector: a dedicated operational sequence in which the washing operation is adapted for washing the dishes with a dishwasher-dedicated detergent; and a normal operational sequence in which the washing operation is adapted for washing the dishes with a common kitchen detergent.

The dishwasher according to the present invention allows the user to use either a dedicated detergent or a kitchen detergent to wash the dishes. In the case where a high level of washing performance is required, a dedicated detergent is available to fully exploit the capability of the dishwasher. If there is no dedicated detergent at hand, a kitchen detergent can instead be used. Thus, the user can select any type of detergent according to the situation. This feature significantly improves the usability.

In a preferable mode of the dishwasher according to the present invention, the operation controller controls the washing means so that the average strength of the sprayed water is lower in the normal operational sequence than that in the dedicated operational sequence. According to this construction, the detergent water sprayed from the washing means hits the dishes and removes the stains from the dishes. If a kitchen detergent is used, the sprayed water is easier to foam than in the case where a dedicated detergent is used. In the present mode, however, the foaming is suppressed because the water is sprayed with a lower average strength. It should be noted hereby that, if the maximum value of the momentary injection pressure of the water spray is too small, the detergent water cannot reach the uppermost section of the dishes, so that the dishes are washed unevenly.

Accordingly, in a more preferable form of the invention, the process of spraying the water for a shorter period of time and then halting the spray for a longer period of time is repeated to decrease the average strength of the water spray. According to this method, the detergent water is widely sprayed over the dishes during the spraying phase, where a large amount of foam easily develops. However, the foam dissipates through the subsequent halting phase. Thus, the amount of the foam produced throughout the entire cycle is reduced. The detergent water sprayed onto the dishes penetrates into the stains on the dishes during the halting phase and makes the stains easy to separate. Therefore, even the averagely weakened water spray can exhibit an adequate level of washing performance.

To ensure a higher level of washing capacity with a kitchen detergent, the operation controller may be constructed so that the total period of time for the washing operation using the detergent water is longer in the case of the normal operational sequence than that in the case of the dedicated operational sequence. According to this construction, when a kitchen detergent is used, the total period of time for the washing operation is extended to compensate for the drop of the washing capacity per unit time resulting from the average decrease in the strength of the water spray. With the drop of the washing capacity thus compensated, the dishwasher exhibits an adequate level of washing performance.

The above-described construction may further include a heating means for heating the water stored in the bottom of the wash chamber, and the operation controller controls the heating means so that the heating temperature for the detergent water is set lower in the case of the normal operational sequence than in the case of the dedicated operational sequence. When the total period of time for the washing operation is set longer as described above, the power consumed by the heating means inevitably increases if the temperature of the detergent water is maintained at a high level. The present construction avoids this problem by setting the heating temperature for the detergent water at a relatively low level to decrease the power consumption when a kitchen detergent is used. The heating temperature hereby may be the maximum value of the heating temperature if the washing operation is carried out only once, or the average of the maximum value for each washing operation if the washing operation is repeated more than once.

The dishwasher according to the present invention may be constructed so that the normal operational sequence includes the following two operations: the first washing operation in which the average strength of the water sprayed from the washing means is relatively lower; and the second washing operation having the steps of draining the detergent water used in the first washing operation, introducing fresh water into the wash chamber, and washing the dishes with the residual detergent, where the average strength of the water spray is set higher than that of the first washing operation.

In the first washing operation, the detergent water has a relatively high detergent concentration while the average strength of the water spray is relatively low. If a stain is firmly stuck on the dishes, the strong detergent water evenly covers the dishes and makes the stain afloat on the dishes. However, the water spray may be too weak to wash off the stain. In the second washing operation, the water spray, which is now stronger on average and lower in detergent concentration than that of the first washing operation, hits the dishes and evenly washes off the stain from the dishes. In the first washing operation, even though the detergent concentration of the water is relatively high, the water hardly foams because the water spray is on average weak. In the second washing operation, the increased strength of the water spray does not produce a large amount of foam because the detergent concentration of the water is very low.

Therefore, the dishwasher can clean the dishes while preventing the detergent water from foaming even if an easy-foaming kitchen detergent is used.

The dishwasher according to the present invention may preferably include a foam detector for detecting the state of the foam developed within the wash chamber, and the operation controller may conduct the washing operation according to an operational sequence corresponding to the state of the foam detected with the foam detector when the washing means is energized with the detergent water stored in the wash chamber.

According to this construction, the operation controller determines the type and the amount of the detergent from the state of the foam. When an extremely large amount of foam is expected to develop, it conducts the washing operation according to an appropriate operational sequence that prevents the detergent water from foaming by, for example, controlling the washing means to spray the water more weakly. Apart from the injection pressure of the water spray, it is possible to appropriately determine or change the operation time, the heating temperature of the detergent water, or some other parameters that affect the development of the foam and the washing performance. According to this construction, even if an abnormally large amount of foam has developed in the course of the operation, the washing operation proceeds through the entire process intended by the user. The operation attains a high level of washing performance while preventing the detergent water from foaming.

In the above-described construction, the operation controller may continue the washing operation through a predetermined final phase even if an abnormal development of foam is detected with the foam detector, and then inform the user of the occurrence of the abnormal development of the foam with an annunciator at the end of the operation. This construction enables the user to know that an abnormal amount of foam has developed during the operation. Therefore, if the stain is not completely washed off from the dishes, the information allows the user to judge that the poor washing result is attributable to an automatic selection or change of the operational sequence, the dilution of the detergent water or some other factor that deteriorates the washing capability. This knowledge will help the user in future dishwashing work.

In a mode of the dishwasher according to the present invention, the foam detector includes: a photosensor having a photoemitter and a photoreceiver facing each other across a space leading to the interior of the wash chamber, where the space is out of the direct reach of the water sprayed from the washing means; and a determining means for examining the output of the photoreceiver of the photosensor to determine whether an abnormal amount of foam is present or not. If the amount of the foam present within the wash chamber is normal, the light emitted from the photoemitter reaches the photoreceiver without undergoing any severe attenuation. If a high-foaming detergent (e.g. a kitchen detergent) is used, or if a relatively low-foaming detergent is used by an excessive amount, there is a possibility that an abnormal amount of foam develops when the washing means sprays, and thereby stirs, the detergent water. If the foam reaches the space between the photoemitter and the photoreceiver, the light emitted from the photoemitter is blocked by the foam as a result of the dispersion of light on the surface of the foam or some other phenomena, so that the amount of the light reaching the photoreceiver decreases and the output of the photoreceiver accordingly drops. If the output is as low as a predetermined percent of the output observed under the normal condition where there is no foam, the determining means judges that an abnormal amount of foam is present.

The dishwasher having the above-described construction utilizes the blocking of the light to check the occurrence of the abnormal development of the foam. This method does not require the foam to completely fill the space between the photoemitter and the photoreceiver; a smaller amount of foam suffices for an abnormal development of the foam to be detected. Therefore, the dishwasher can quickly and correctly detect an abnormal development of the foam and take necessary actions against it. Also, in the present construction, the electrical conductivity or other physical properties of the foam does not affect its detection. Therefore, whatever kind of detergent (e.g. a neutral synthetic detergent, an alkalescent synthetic detergent, or soap) is used, the foam detector can assuredly detect an abnormal development of the foam.

In a more specific mode, the photosensor is located within a drying duct connected to the lower section of the wash chamber to supply a drying wind into the wash chamber. In this construction, the water sprayed from the washing means into the wash chamber is prevented from hitting the photosensor directly or passing the space between the photoemitter and the photoreceiver. If an abnormal amount of foam develops within the wash chamber, a portion of the foam enters the duct through the outlet port located in the lower section of the wash chamber. This portion of the foam rapidly ascends to reach the photosensor because the drying duct has a relatively small cross section. Thus, the present construction assuredly detects the abnormal development of the foam within the wash chamber in an early phase of the development of the foam.

The dishwasher may further include an operation controller for carrying out a defoaming process to extinguish the foam and thereby recover a state where the operation can be further continued, if an abnormal amount of foam is detected with the foam detector. Preferably, the defoaming process should not only remove the foam present at the moment but also suppress the development of the foam in the subsequent operations. As a specific example, the defoaming process drains a portion or the entirety of the detergent water stored in the wash chamber and supply fresh water to compensate for the loss of the detergent water. This process lowers the detergent concentration of the detergent water, thereby suppressing the development of the foam. According to this method, even if an abnormal amount of foam has developed within the wash chamber, the operation does not stop at the moment but the washing operation continues through the initially programmed steps after lowering the detergent concentration of the detergent water as described above. There is no need to perform the washing operation again, so that the user can save time as well as water, electric power and detergents.

The dishwasher may preferably include an annunciator for informing the user of the development of an abnormal amount of foam if the foam is detected by the foam detector. The annunciation signal may be produced when the foam is detected. In the case where the operation is continued as described above, it is preferable to produce the annunciation signal when the entire process is finished. Particularly, if the annunciator uses a buzzer or an audio message to warn the user, it is preferable to make the warning action when the entire process is finished and the user is allowed to take out the dishes from the wash chamber, for beeping in the course of operation is bothersome. In this construction, the user can know that an abnormal amount of foam developed in the dishwasher, which allows the user to check the type or amount of detergent used.

In the dishwasher according to the present invention, the photoemitter and the photoreceiver of the photosensor may be located so that: the light emitted from the photoemitter to the photoreceiver travels along a path inclined to a horizontal surface; and the foam detector is also capable of detecting the water level in the wash chamber.

In this construction, if the light emitted from the photoemitter enters the water before it reaches the photoreceiver, the amount of light reaching the photoreceiver significantly decreases due to the reflection (i.e. scattering) or refraction of the light at the water surface. Therefore, if the output of the photoreceiver has dropped, the determining means can assess the possibility that the water stored in the wash chamber has risen close to the level where the photosensor is located. The drop of the output of the photoreceiver implies two possibilities: the presence of the foam, or that of the water surface, on the optical path between the photoemitter and the photoreceiver. Accordingly, in a specific mode of the present invention, a drop of the output of the photoreceiver makes the determining means monitor the output of the photoreceiver continuously for a predetermined period of time, or intermittently a plurality of times, to determine whether the drop is due to a development of the foam or a rise of the water level.

In the case where the output drop is due to the foam, the low-output state continues as long as the foam remains. In the case where the output drop is due to a rise of the water level, the output of the photoreceiver considerably recovers when the water reaches a level where the optical path from the photoemitter to the photoreceiver is entirely submerged under the water and the light no longer undergoes the reflection or refraction on the water surface. Therefore, it is possible to determine whether the output drop is due to the presence of the foam or a rise of the water level, by continuously keeping track of the temporal change in the output, or by checking whether the output drop is still detectable when a predetermined period of time has lapsed since the previous detection of the output drop. Thus, the foam detector can be used to detect the rise of the water at the level of the photosensor.

It should be noted that the use of the foam detector enables the detection of only one water level in the vicinity of the level where the photosensor is located, whereas a dishwasher usually needs to detect the water at multiple levels. Accordingly, in a preferable version of the above-described construction, the dishwasher further includes a level detector for detecting the level of the water stored in the wash chamber, and the foam detector is used to detect the water level only when the level detector is evidently malfunctioning.

In this construction, the level detector is evidently regarded as malfunctioning if, for example, the output of the level detector significantly fluctuates although the water level is actually constant. In such a situation, if a rise of the water level is detected from the change in the output of the photosensor, the rise is determined as abnormal. Then, to prevent any additional rise of the water level in the wash chamber, the washing means is stopped and the water is drained from the wash chamber. Thus, according to this construction, if the level detector is malfunctioning, the foam detector is used as a level detector for detecting an abnormal rise of the water stored in the wash chamber. Therefore, it is possible to prevent the water from reaching the overflow level of the wash chamber and escaping to the outside.

In another version, the dishwasher further includes a level detector for detecting the level of the water stored in the wash chamber, and the level detector is used to detect the level of the water stored for the washing or rinsing operation, while the foam detector is used to detect an abnormal water level. According to this construction, the level detector needs only to detect a single water level. Such a detector can be constructed at a low cost, using a level switch or a similar device having a simple construction.

In another mode of the dishwasher according to the present invention: the dishwasher includes:

a drying duct connected to the lower section of the wash chamber to supply a drying wind into the wash chamber, with the photoemitter and the photoreceiver of the photosensor being located within the drying duct, facing each other;

a drainage pipe through which the water stored in the bottom of the wash chamber is drained to the outside;

a water supplier for supplying water from the outside into the wash chamber; and

a branch pipe having one end connected to the drainage pipe or the water supplier and the other end opened to the interior of the drying duct so that a portion of the water drained through the drainage pipe, or a portion of the water supplied through the water supplier, is poured onto the photosensor.

In this construction, if an abnormal amount of foam present in the wash chamber has reached the photosensor through the drying duct, the light emitted from the photosensor hardly reaches the photoreceiver because the foam blocks the light. This results in a drop of the output of the photoreceiver, from which the determining means detects the abnormal development of the foam. If the opposite faces of the photoemitter and the photoreceiver of the photosensor are stained, the output of the photoreceiver drops even if there is no foam, causing a misdetection of the foam. In the above-described construction, every time the water stored in the wash chamber is drained to the outside, a portion of the water is brought through the branch pipe back into the drying duct and poured onto the opposite faces of the photoemitter and the photoreceiver of the photosensor. Alternatively, every time the water supplier supplies water into the bottom of the wash chamber, a portion of the water is brought through the branch pipe back into the drying duct and poured onto the opposite faces of the photoemitter and the photoreceiver of the photosensor. These operations remove any stain remaining on the opposite faces of the photoemitter and the photoreceiver of the photosensor before the stain becomes dried and firmly sticks to the faces. Thus, the misdetection of the foam due to a stain on the photosensor is prevented. Supplying water through the drying duct also has the effect of extinguishing the foam filling the drying duct and washing the foam into the wash chamber.

To assuredly pour the water from the open end of the branch pipe onto the photoemitter and the photoreceiver of the photosensor, the above-described construction may further include a water guide for guiding the water from the end of the branch pipe opened to the interior of the drying duct to the photoemitter and the photoreceiver of the photosensor. The water guide should be formed so that it does not disturb the air flowing through the drying duct. According to this construction, even if the amount of water supplied through the branch pipe is small, the water assuredly washes off the stains from the opposite faces of the photoemitter and the photoreceiver of the photosensor.

According to another mode of the present invention, the dishwasher includes:

a water supplier for supplying water from the outside into the wash chamber;

a drainage means for draining the water from the bottom of the wash chamber into a drainage pipe leading to the outside;

a drying duct connected to the lower section of the wash chamber to supply a drying wind into the wash chamber; and

a branch pipe having one end connected the drainage pipe or the water supplier and the other end opened to the interior of the drying duct so that the drying duct is flushed with a portion of the water drained through the drainage pipe or a portion of the water supplied through the water supplier.

In this construction, when the drainage means is activated during a drainage operation to drain water from the wash chamber to the outside, the drainage means draws the water from the bottom of the wash chamber and sends it into the drainage pipe. In the case where an end of the branch pipe is connected to the drainage pipe, most of the water sent from the drainage means flows through the drainage pipe to the outside, while the remaining portion of the water flows through the branch pipe into the drying duct. Since the outlet port of the drying duct is located in the lower section of the wash chamber, the foam enters through the outlet port into the drying duct if a large amount of foam is produced during the washing or rinsing operation. However, the water ejected from the open end of the branch pipe extinguishes a portion of the foam and also washes the other portion through the outlet port into the wash chamber. In the case where the aforementioned end is connected to the water supplier, such as a feed valve or a supply pipe, the water flows through the drying duct every time fresh water is supplied, thereby extinguishing the foam or washing the foam into the wash chamber.

Thus, in the present construction, the foam cannot fill the drying duct and accumulate therein. Therefore, the foam is prevented from escaping through the inlet port (i.e. entrance) of the drying duct, or through a joint of the drying duct, to the outside. The construction also prevents the foam present in the drying duct from blowing off the outlet port and sticking to the dishes during the drying operation.

To ensure the defoaming effects, the open end of the branch pipe should be preferably located at a level higher than the uppermost portion of the foam entering the drying duct when an abnormal amount of foam is present within the wash chamber. This construction helps the water to hit the entire amount of foam that has entered the drying duct. Particularly, it effectively prevents the foam from remaining in the upper section of the drying duct. The drainage means and the water supplier are naturally activated when the water stored in the wash chamber is entirely replaced after the washing or rinsing operation. Moreover, they may be activated for the purpose of defoaming, or of diluting the detergent water in the wash chamber by discharging a portion of the detergent water from the wash chamber and adding fresh water.

In another mode of the present invention, the dishwasher includes:

a drying duct connected to the lower section of the wash chamber to supply a drying wind into the wash chamber;

a blower having a fan for drawing air from the outside and sending it through the drying duct into the wash chamber; and

a controller for driving the fan to thrust the foam from the drying duct back into the wash chamber if an abnormal amount of foam is detected during the washing or rinsing operation, or if an abnormal amount of foam is likely to develop.

In this construction, the fan is activated under the control of the controller if an abnormal amount of foam has developed within the wash chamber during the washing or rinsing operation with a portion of the foam entering the drying duct through the outlet port, or if an abnormal amount of foam is likely to develop. The fan draws the external air into the inlet port and generates a stream of air flowing from the inlet port through the drying duct to the outlet port. This air stream thrusts the foam in the drying duct back to the outlet port. Thus, if an abnormal amount of foam is present within the wash chamber, the foam that has entered the drying duct is promptly removed. The dishwasher is originally provided with a fan for the drying operation. This means that a simple change in the control program will provide a mechanism for removing the foam from the drying duct, using existing hardware elements (mechanics and circuits). Since there is no need to add a special hardware element, it is possible to add the foam-removing mechanism with only a slight increase in cost.

Depending on the position of the outlet port, it is possible that a majority or the entirety of the outlet port is sealed with the water stored in the bottom of the wash chamber. If this happens, the air hardly flows from the drying duct into the wash chamber, so that the air stream barely generates through the drying duct when the fan is activated. In such a structure, it is preferable to provide a communicating element for enabling the interior of the drying duct to communicate with the interior of the wash chamber at a position that is higher than the normal level of the stored water and is the lowest possible level within the drying duct. According to this construction, even if the outlet port is entirely sealed with the water, the communicating element allows the air to flow between the wash chamber and the drying duct. Therefore, the air streams from the outside into the wash chamber through the drying duct when the fan is activated. This air stream assuredly thrusts the ascending foam back to the wash chamber through the drying duct.

In another mode of the present invention, the dishwasher includes: a door for closing the front opening of the wash chamber; and an annunciator for cautioning the user against opening the door during one or more specific steps of the normal operational sequence, or during one or more predetermined periods within time of such specific steps, assuming that an abnormal amount of foam is present within the wash chamber. The annunciator may be a sound generator for producing an alarm sound, an indicator for showing an alarm signal or a combination of the two devices. In still another mode of the present invention, the dishwasher includes: a door for closing the front opening of the wash chamber; and a door-locking means for preventing the user from opening the door during one or more specific steps of the normal operational sequence, or during one or more predetermined periods of time within such specific steps, assuming that an abnormal amount of foam is present within the wash chamber.

In the normal operational sequence, a large amount of foam easily develops within the wash chamber because a high-foaming kitchen detergent is used. The step in which the foam is particularly easy to develop is the washing step in which water containing the kitchen detergent is sprayed onto the dishes. Also in the rinsing step, which follows the washing step, a large amount of foam may develop due to the residual kitchen detergent present in the water stored in the wash chamber. Accordingly, the aforementioned specific step, which is typically the washing step using the detergent water, may further include the rinsing step that follows the washing step. The aforementioned predetermined step may be a period of time in which the foam is particularly easy to develop. An example is the period of time in which the water is strongly sprayed by the washing means during the washing step.

In the above-described two modes of the invention, the user is cautioned against opening the door or prevented from opening the door when the possibility that an abnormal amount of foam is present within the wash chamber is considerably high, irrespective of whether such an amount of foam is actually present within the wash chamber. Therefore, the foam is assuredly prevented from escaping to the outside even if the foam detector cannot detect the foam with high accuracy or the foam detector is malfunctioning.

### BRIEF DESCRIPTION OF THE DRAWINGS

FIG. 1 is a front view of a dishwasher as an embodiment of the present invention.

FIG. 2 is a side vertical sectional view of the dishwasher of the embodiment, viewed from a side.

FIG. 3 is a schematic side view of the main structure of the drying duct located inside the right flank of the dishwasher of the embodiment.

FIG. 4 is an enlarged view of a section of FIG. 3, including the photosensor and other nearby. elements.

FIG. 5 is a vertical sectional view of the section shown in FIG. 4, viewed from the front.

FIG. 6 is a block diagram showing the electrical system of the main part of the dishwasher of the embodiment.

FIG. 7 is a detailed diagram of the control system for the pump motor used in the dishwasher of the embodiment.

FIG. 8 is a flowchart showing normal operation steps of the dishwasher of the embodiment in which a dedicated detergent is used.

FIG. 9 is a flowchart showing the steps of a kitchen detergent course of the dishwasher of the embodiment, in which a kitchen detergent is used.

FIG. 10 is a control flowchart of the washing operation in an operation course assuming the use of a dedicated detergent.

FIG. 11 is a control flowchart of the first washing operation of the kitchen detergent course.

FIG. 12 is a control flowchart of the second washing operation of the kitchen detergent course.

FIG. 13 is a graph showing the temperature of the water changing with the progress of the operation course assuming the use of a dedicated detergent.

FIG. 14 is a graph showing the temperature of the water changing with the progress of the kitchen detergent course.

FIGS. 15A and 15B are diagrams schematically showing the detecting operation of the photosensor.

FIG. 16 is a flowchart of the foam-detection process carried out during the washing operation using a dedicated detergent.

FIG. 17 is a flowchart of a process of displaying a “No Opening the Door” indication.

FIG. 18 is a flowchart of another process of displaying a “No Opening the Door” indication.

FIG. 19 is a flowchart of a washing operation using a detergent-identifying function.

FIG. 20 is a flowchart of a process in which the output of the photosensor is utilized in both the foam detection and the abnormal level detection.

FIG. 21 is a graph showing the temporal change of the detection output of the photo sensor.

FIG. 22 is a flowchart of another example of the process in which the output of the photosensor is utilized in both the foam detection and the abnormal level detection.

### BEST MODE FOR CARRYING OUT THE INVENTION

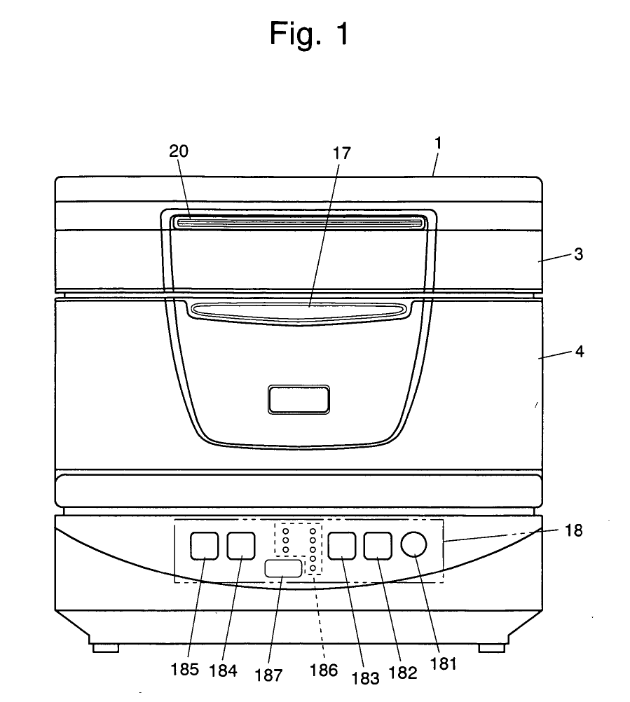

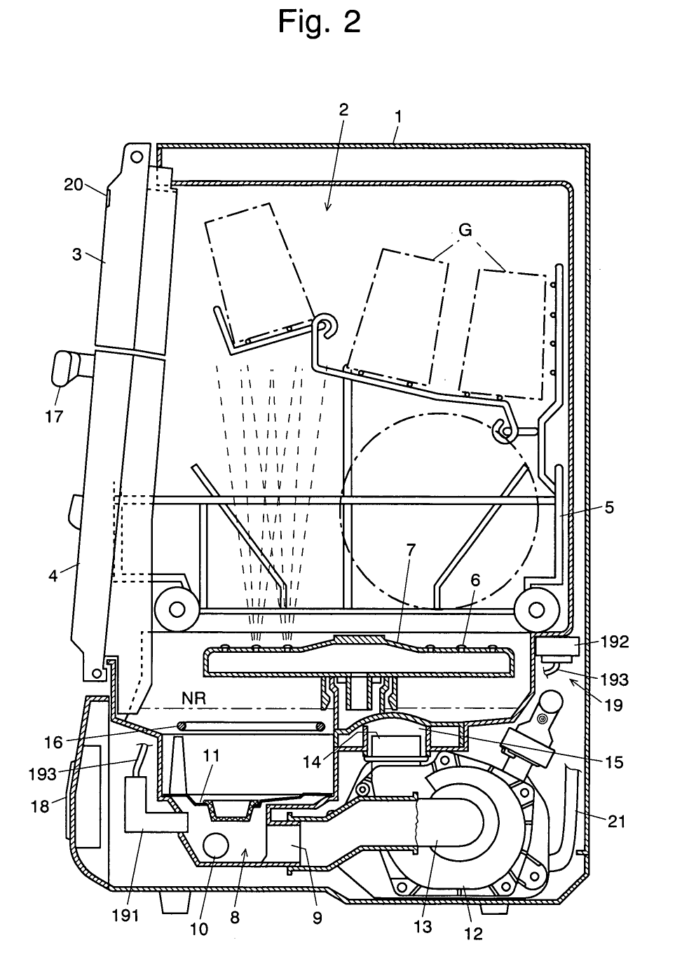

A dishwasher as an embodiment of the present invention is described with reference to the attached drawings: FIG. 1 is a front view of the dishwasher of the present embodiment, and FIG. 2 is a vertical sectional view of the dishwasher viewed from a side. The present dishwasher is a slim type dishwasher having a small depth so that it can be placed in a small area, such as the top area adjacent to the sink of the kitchen.

The housing 1 encloses a wash chamber 2, which also serves as a drying chamber. The front opening of the wash chamber 2 is equipped with an upper door 3, which is fixed to a shaft at the upper end, and a lower door 4, which is fixed to another shaft at the lower end. The two doors constitute double doors that swing upwards and downwards. The lower door 4 has a handle 17 located at the center of its upper end. When a user holds the handle 17 and pulls it forward to open the lower door 4, the upper door 3 also opens upwards because the two doors are interlocked. Located below the lower door 4 is an operation panel 18 having an operation unit 18a with a power switch 181, a start key 182, a course selection key 183, a drying key 184, a kitchen detergent course key 185 and other components. The course selection key 183 is used to select one of multiple operation courses each of which basically uses a dedicated detergent to wash the dishes. The drying key 184 is used if the dishes need only to be dried. The kitchen detergent course key 185 should be operated when the dishes are to be washed with a kitchen detergent instead of a dedicated one. The operation panel 18 also has a display unit 18b including a course indicator 186, which shows the course selected with the course selection key 183, and a condition indicator 187, which shows the drying time, the enable/disable setting of the hot water supply and other information.

When the upper and lower doors 3 and 4 are open, a rack 5 can be moved into or out of the wash chamber 2. A section of the rack 5 (i.e. the rear section in the present case) includes a lower basket for containing small plates, bowls and similar dishes, and an upper rotary shelf 5a on which cups and glasses G are to be set. At the bottom of the wash chamber 2, a rotary wash arm 6 having plural nozzles 7 on its top is provided as a component of the washing means. Since the width of the wash chamber 2 is larger than the depth, it is impossible to supply water to both ends of the wash chamber 2 with only a single wash arm. Therefore, the dishwasher also has another wash arm (not shown) located at a position where it does not interfere with the first wash arm 6 during the rotation.

At the bottom of the wash chamber 2, a recess is formed as a reservoir 8, the top of which is covered with a removable filter 11 for catching food particles washed off from the dishes. On one side of the wash chamber 2, a water inlet (not shown) having a feed valve is located. When the feed valve is opened, the water supplied from an external tap or a similar source is poured through the water inlet into the wash chamber 2 and stored in the bottom of the wash chamber 2 including the reservoir 8.

The level of the water stored in the wash chamber 2 is detected by a level sensor 19 corresponding to the level detector of the present invention. The level sensor 19 is composed of an air trap 191 leading to the reservoir 8, a pressure sensor 192 located at a low position behind the back of the wash chamber 2, and an air hose 193 connecting the air trap 191 and the pressure sensor 192. A change in the water level in the wash chamber 2 causes a change in the pressure of the air within the air trap 191. Detecting this pressure change with the pressure sensor 192 enables the detection of the water at the normal level line NR for the washing or rinsing operation and at an abnormal water level corresponding to an excessive amount of water. In the bottom of the wash chamber 2, a loop-shaped heater 16 as the heating means of the present invention is located at a level lower than the normal level line NR. The heater 16 is used to warm the water stored in the wash chamber 2 and heat the air in the wash chamber 2 during the drying operation.

Beneath the bottom wall of the wash chamber 2, a wash and drainage pump 12 is provided as a part of the washing means and also as a part of the drainage means. The pump 12 internally has a wash pump room and a drainage pump room separated from each other by a partition wall. The wash pump room and the drainage pump room contain a wash impeller and a drainage impeller, respectively, both being connected to the same shaft of a pump motor 12a. The inlet 13 of the wash pump room is connected to a circulation port 9 located at the back wall of the reservoir 8, and the outlet 14 leads to the water channels of the first wash arm 6 and the second wash arm (not shown) through a laterally extending water passage 15. Though not shown in the drawings, the inlet of the drainage pump room is connected to a drainage port 10 located at the side wall of the reservoir 8, and the outlet of the drainage pump room leads to the outside through a drainage hose 21.

With water stored in the bottom of the wash chamber 2, when the pump motor 12a of the wash and drainage pump 12 is rotated in the forward direction, the pump 12 acts as the wash pump. In this case, the rotation of the wash impeller draws water from the reservoir 8 into the circulation port 9 and thrusts the water through the water passage 15 to the wash arm 6. Then, the water is sprayed upwards from the nozzles 7 located on the top of the wash arm 6, and the jet of water makes the wash arm 6 rotate around an approximately vertical axis in a predetermined direction. The water sprayed from the nozzles 7 hits the dishes contained in the wash chamber 2, thereby washing the stain or the detergent from the surface of the dishes. When the pump 12a is rotated in the reverse direction, the wash and drainage pump 12 acts as the drainage pump. In this case, the rotation of the drainage impeller draws water from the reservoir 8 into the drainage port 10 and discharges the water through the drainage hose 21 to the outside.

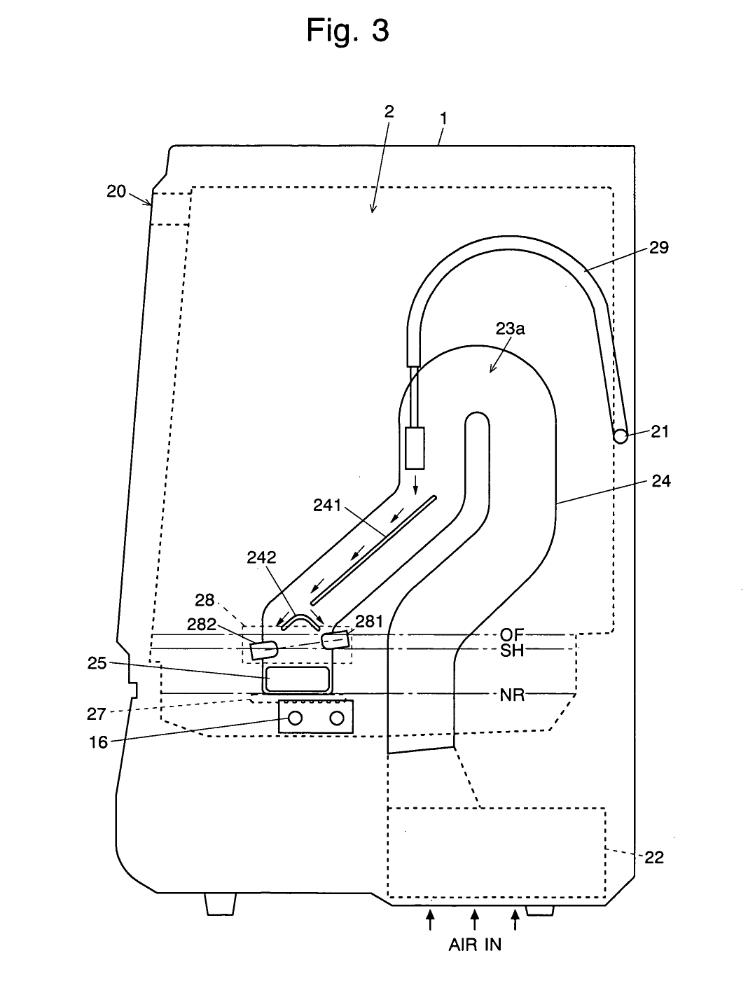

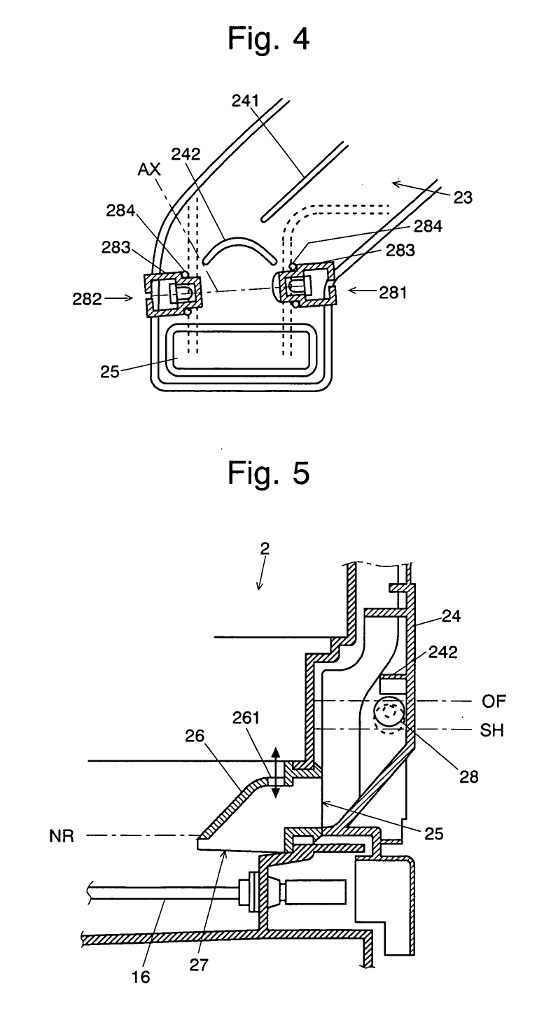

FIG. 3 is a schematic side view of the main structure of the drying duct 23 located inside the right flank of the present dishwasher, FIG. 4 is an enlarged view of a section of FIG. 3, including the photosensor and other nearby elements, and FIG. 5 is a vertical sectional view of the same portion viewed from the front.

At the bottom of the wash chamber 2, a blower 22 is located next to the wash and drainage pump 12. Though not shown in the drawing, the blower 22 includes a blowing fan enclosed in a fan casing and a fan motor for rotating the blowing fan. From the fan casing, the drying duct 23 extends obliquely backwards and then upwards, leading to an inverted U-shaped section (or a bent section 23a), from which the duct further extends downwards and then obliquely forwards. The drying duct 23 is formed by the right side wall of the wash chamber 2 and an external air passage cover 24 attached to the aforementioned side wall of the wash chamber 2. The lower end of the external air passage cover 24 is connected to the air inlet 25 formed in the side wall of the wash chamber 2. The drying duct 23 leads through the internal air passage cover 26 to the outlet port 27 that is open to the interior of the wash chamber 2. When the fan rotates, the external air is drawn into the air inlet formed at the bottom of the housing 1. Then, the air flows through the drying duct 23 and the outlet port 27, and enters the wash chamber 2. Meanwhile, the damp air existing in the wash chamber 2 is discharged through the front exhaust port 20 to the outside.

Inside the drying duct 23 and downwards from the bent section 23a, a photosensor 28 for detecting the foam produced within the wash chamber 2 is located at the foam detection line SH. This line is slightly lower than the overflow line (OF), or the lower end of the front opening of the wash chamber 2. In other words, the line SH is higher than the normal level line NR and lower than the overflow line (OF). The photosensor 28 consists of a photoemitter 281 and a photoreceiver 282 facing each other in the front-to-rear direction across the drying duct 23. The position of the photoemitter 281 is slightly higher than that of the photoreceiver 282 so that the optical axis AX between the photoemitter 281 and the photoreceiver 282 is slightly inclined from the horizontal. For example, the photoemitter 281 is a light-emitting diode and the photoreceiver 282 is a photodiode. Each of these elements is enclosed in a transparent attachment case 283, which is attached to the external air passage cover 24 via a seal member 284 that ensures the air-tightness and water-sealing capability.

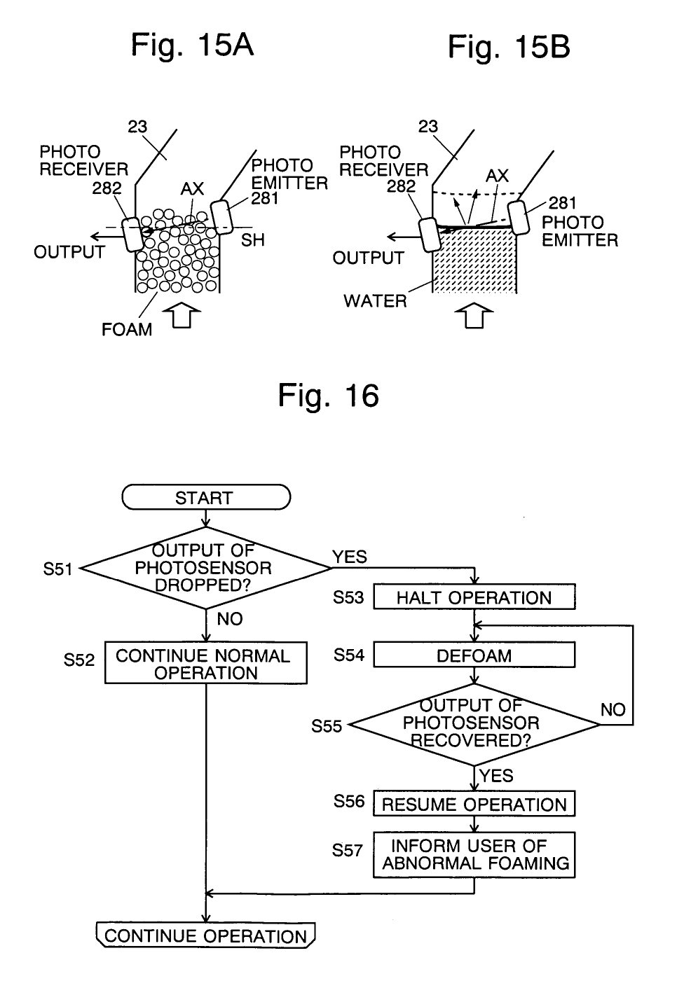

FIGS. 15A and 15B are diagrams schematically showing the detecting operation of the photosensor 28. The light emitted from the photoemitter 281 reaches the photoreceiver 282 and is detected thereby. If, as shown in FIG. 15A, the foam that has abnormally developed within the wash chamber 2 ascends the drying duct 23 from the outlet port 27 to a level beyond the foam detection line SH, the foam blocks the light emitted from the photoemitter 281, so that the amount of light reaching the photoreceiver 282 decreases. This causes a drop of the signal strength of the photoreceiver 282. An occurrence of this signal drop indicates that the foam has reached the foam detection line SH, or that an abnormal amount of foam has developed.

The photosensor 28 can be also used for the detection of an abnormal water level. As shown in FIG. 15B, if the water stored in the wash chamber 2 rises to a level beyond the foam detection line SH, the light emitted from the photoemitter 281 strikes the water surface with a large incident angle before it reaches the photoreceiver 282. Therefore, a considerable portion of the light is reflected (or scattered) at the water surface, so that the amount of light reaching the photoreceiver 282 decreases.

If an abnormal amount of foam has developed, the amount of light received by the photoreceiver 282 usually remains at the decreased level because the foam does not quickly disappear until a defoaming process, such as described later, is carried out after the foam has reached the foam detection line SH. In contrast, in the case where the decrease in the amount of light received by the photoreceiver 282 is due to a rise of the water level to the foam detection line SH in the wash chamber 2, if a further rise of the water level has brought the water surface to a level higher than the photoemitter 281, the light emitted from the photoemitter 281 travels through the water and reaches the photoreceiver 282. In this case, the amount of the light received by the photoreceiver 282 considerably recovers, though not as high as in the air. Thus, using the same photosensor 28, it is possible to distinguish the abnormal development of foam and the abnormal rise of the water level by monitoring the temporal change of the amount of the light received by the photoreceiver 282 over a certain period of time. This point will be discussed in detail later.

If the opposite faces of the photoemitter 281 and the photoreceiver 282 of the photosensor 28 are stained, the amount of the received light accordingly decreases, so that the foam and the water level cannot be correctly detected by the above-described methods. Therefore, a branch hose 29 is installed to wash the opposite faces of the photoemitter 281 and the photoreceiver 282. One end of the branch hose 29 diverges from the drainage hose 21 located in the rear section of the housing 1, and the other end is inserted into the drying duct 23 at a position close to the bent section 23a. Also, a water guide consisting of a first rib 241 extending linearly and obliquely and a second rib 242 having an inverted V-shape is located within the external air passage cover 24.

When, as described earlier, the wash and drainage pump 12 is energized as the drainage pump to start draining water through the drainage hose 21, a portion of the water is introduced through the branch hose 29 into the drying duct 23. The introduced water flows down the first rib 241 and is separated by the second rib 242 into two flows. Each flow of water is poured onto each of the opposite faces of the photoemitter 281 and the photoreceiver 282, whereby any dust or stain existing on these faces is washed off.

At the top of the internal air passage cover 26 located close to the outlet port 27, an air hole 261 for enabling the interior of the wash chamber 2 to communicate with the interior of the drying duct 23 is formed at a position higher than the normal level line NR. As described later, the air hole 261 enables the air to flow from the drying duct 23 into the wash chamber 2 without passing the outlet port 27 when the blowing fan is activated during the washing or rinsing operation with the outlet port 27 being sealed with the water.

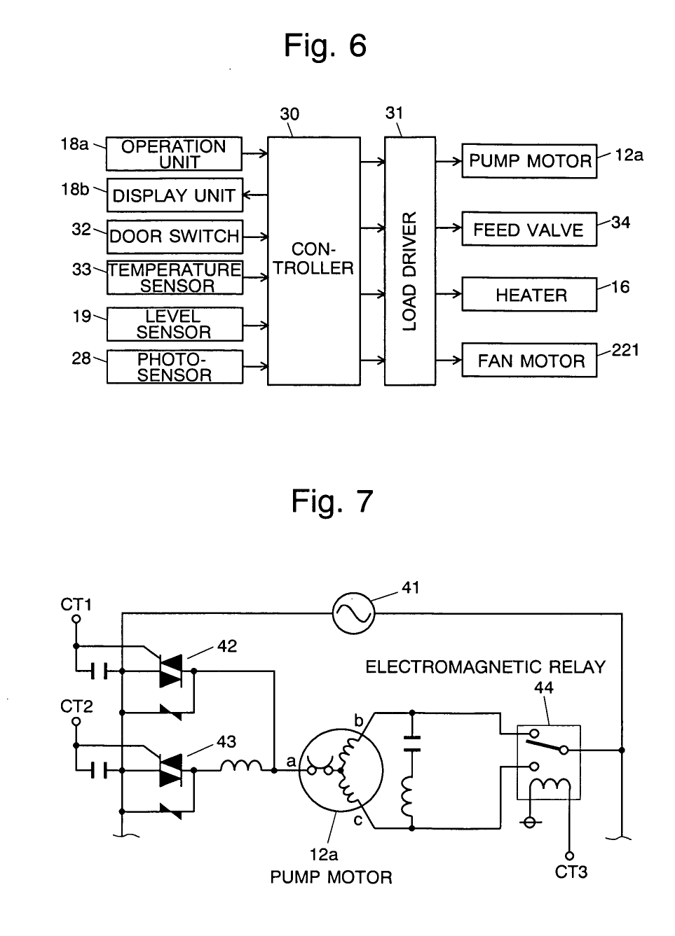

FIG. 6 is a block diagram showing the electrical system of the main part of the dishwasher of the present embodiment. The controller 30, which corresponds to the controller or the operation controller of the present invention, includes a microprocessor as its main component. It is connected, via the load-driving circuit 31, to the pump motor 12a, the feed valve 34, the heater 16 and the fan motor 221. Also connected to the controller 30 are the operation unit 18a, the display unit 18b, the door switch 32, the temperature sensor 33, the level sensor 19, the photosensor 28 and other elements. The controller 30 also includes a read only memory (ROM) in which a control program is stored. The central processing unit (CPU) executes the control program to conduct various operations described later.

FIG. 7 is a detailed diagram of the control system for the pump motor 12a. As explained earlier, the present dishwasher makes the wash and drainage pump 12 function either as a wash pump or a drainage pump by changing the rotating direction of the pump motor 12a. The two terminals b and c, which determine the rotating direction of the pump motor 12a, are connected to the two switching terminals of an electromagnetic relay 44. The common terminal of the electromagnetic relay 44 is connected to an end of the commercial AC power supply 41. Turning on and off the control current CT3 supplied to the coil of the electromagnetic relay 44 changes the rotating direction of the pump motor 12a.

Between the other terminal a of the pump motor 12a and the other end of the commercial AC power supply 41, bidirectional three-terminal thyristors (or triacs) 42 and 43 connected in parallel are inserted to switch the speed of the pump motor 12a. Complementary on/off switching of the control signals CT1 and CT2 inputted into the two triacs changes the speed of the pump motor 12a. On the assumption that the frequency of the commercial AC power supply is 50 Hz, the pump motor 12a rotates at 2700 r.p.m. in the strong operation mode, or at 2300 r.p.m. in the weak operation mode, about 85% of the speed in the strong operation mode.

In the strong operation mode, the water pressure (or discharge pressure) from the wash and drainage pump 12 is high, and the injection pressure of the water from the wash arm 6 is accordingly high, so that the dishes are washed with a strong power. On the other hand, since the water stored in the wash chamber 2 is stirred with an accordingly strong power, the water is liable to foam if a kitchen detergent is used. In contrast, in the weak operation mode, the water pressure (or discharge pressure) from the wash and drainage pump 12 is low, and the injection pressure of the water from the wash arm 6 is accordingly low, so that the power of washing the dishes is relatively weak. However, the possibility of an abnormal development of the foam is relatively low even if a kitchen detergent is used. It also has the effect of suppressing the impulsive sound generated by the water striking the dishes and the inner wall of the wash chamber 2. This contributes to a silent operation.

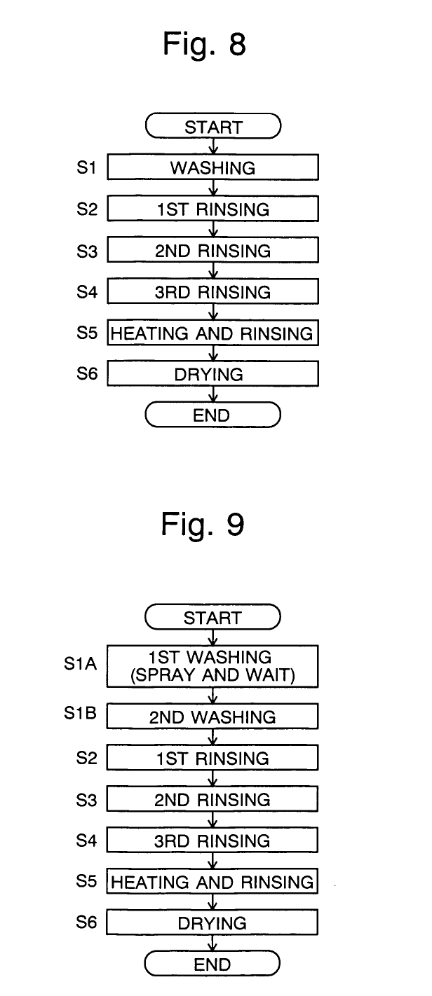

FIG. 8 is a flowchart showing normal operation steps of the dishwasher of the present embodiment in which a dedicated detergent is used. After setting the dishes in the rack 5, the user opens the doors 3 and 4 and sets the rack 5 into the wash chamber 2. Then, he or she puts an adequate amount of the dedicated detergent into the wash chamber 2, and closes the doors 3 and 4. Finally, the user operates the course selection key 183 on the operation unit 18a to select a desired operation course, and presses the start key 182. In response to this key operation, the controller 30 starts the operation.

After the start of the operation, a washing operation is carried out using detergent water containing the dedicated detergent dissolved into water (Step S1). Next, a rinsing operation is repeated three times to wash off the detergent water remaining on the dishes (Steps S2-S4). Subsequently, a heating and rinsing operation is carried out using hot water to eliminate bacteria and warm the dishes so that they can be dried more efficiently in the subsequent drying stage (Step S5). Finally, in the drying operation, hot air is supplied into the wash chamber 2 (Step S6). The entire process is finished after the drying operation is done for a predetermined period of time.

In addition to the aforementioned various courses using the dedicated detergent, the present dishwasher has the kitchen detergent course, an operational course that uses a kitchen detergent. FIG. 9 is a flowchart showing the overall steps of the kitchen detergent course.

In the present case, after setting the dishes into the wash chamber 2, the user puts a kitchen detergent into the wash chamber 2 instead of the dedicated detergent, and closes the doors 3 and 4. Then, the user presses the kitchen detergent course key 185 and the start key 182 on the operation unit 18a. In response to this key operation, the controller 30 starts the operation of the kitchen detergent course.

The most important difference between the kitchen detergent course and the other courses using dedicated detergents is that the kitchen detergent course carries out the washing operation twice. The first washing operation (Step S1A) uses detergent water containing a kitchen detergent dissolved in water. This operation is a “spray and wait” process in which the following two actions alternately take place: spraying the detergent water onto the dishes for a short period of time, and halting the spraying action for a longer period of time. Subsequently, the water in the wash chamber 2 is renewed, and the second washing operation is carried out using detergent water having a very low detergent concentration, which contains only a small amount of the detergent remaining after the water used in the first washing operation is drained (Step S1B). The processes that follow the two washing operations are the same as in the operational course using a dedicated detergent: three cycles of rinsing operations, a heating and rinsing operation and a drying operation.

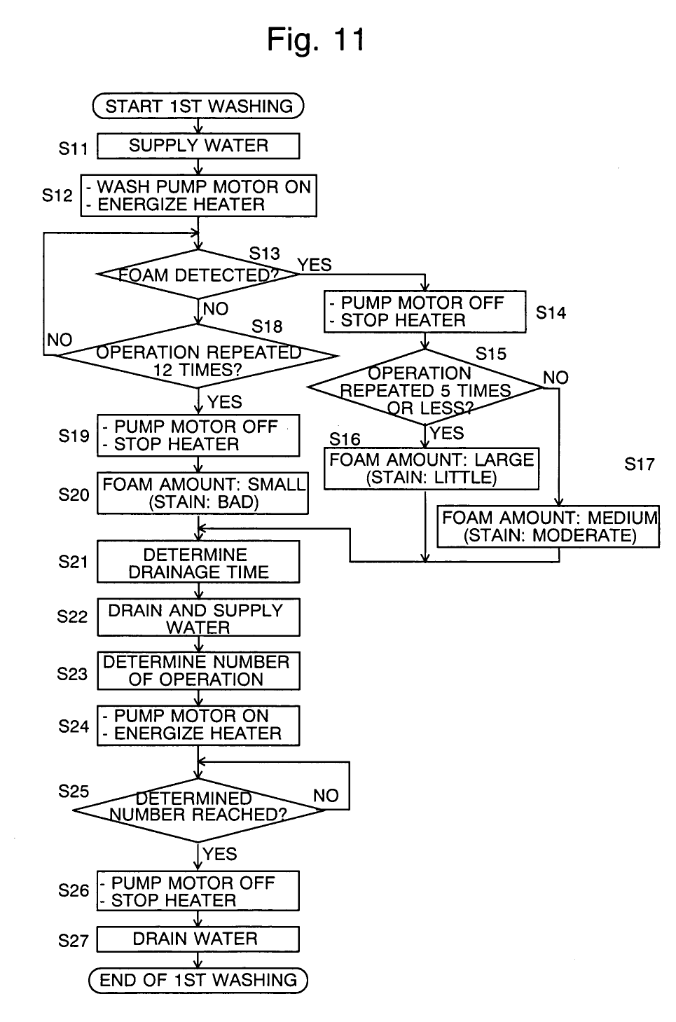

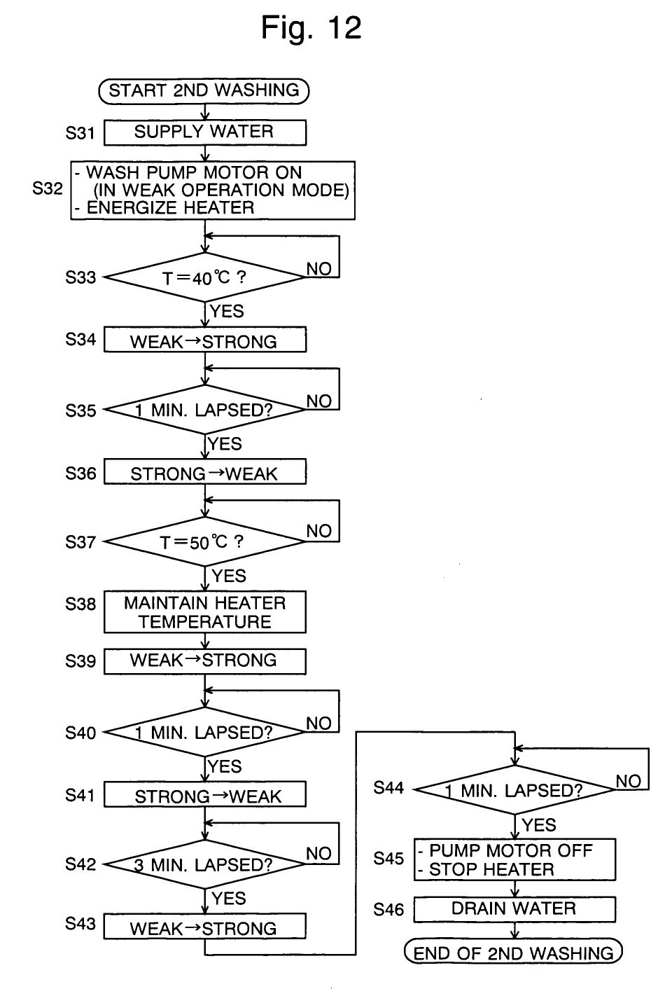

As described above, the major difference between the operation course assuming the use of a dedicated detergent and the kitchen detergent course exists in the washing operation. Accordingly, the following description details the washing operation. Firstly, the first and second washing operations of the kitchen detergent course are described. FIG. 11 is a flowchart showing the details of the first washing operation (Step S1A), FIG. 12 is a flowchart showing the details of the second washing operation (Step S1B), and FIG. 14 is a graph roughly showing the temperature of the water changing with the progress of these operations.

At the start of the first washing operation, the controller 30 opens the feed valve 34 to supply water into the wash chamber 2. When the level sensor 19 detects the water at the normal level line NR, the controller 30 closes the feed valve 34 to stop the water supply (Step S11). Subsequently, it starts the initial operation by activating the pump motor 12a as the wash pump motor and simultaneously energizing the heater 16 (Step S12). The heater 16 heats the detergent water stored in the wash chamber 2, and the heated water is thrust toward the wash arm 6 and then sprayed from the nozzles 7 onto the dishes. The initial operation, which is a “spray and wait” process, provides an opportunity to check the amount of the foam produced within the wash chamber 2, or to check how much the dishes are stained.

In the initial operation, the pump motor 12a is controlled so that a process called “Spray and Wait Process No. 1” is repeated up to twelve times. The “Spray and Wait Process No. 1” process includes an intermittent operation having five on/off cycles conducted in the strong operation mode, followed by a 30-second intermission. Each on/off cycle includes a 0.2-second “on” period followed by a one-second “off” period.

The strong intermittent operation sprays the detergent water onto the dishes only for a short period of time, whereby the stains remaining on the dishes are removed. Even the short-period washing operation produces a certain amount of foam because the kitchen detergent easily foams. However, the foam dissipates through the subsequent 30-second intermission.

Under the condition that amount of the kitchen detergent used is the same, the amount of the foam produced within the wash chamber 2 depends on how much the detergent water is stained due to the stains on the dishes. If the dishes are badly stained, there will be a relatively small amount of foam. In contrast, if the dishes are lightly stained, there will be a larger amount of foam. Therefore, if the dishes are stained moderately or lightly, a large amount of foam will develop while the “Spray and Wait Process No.1” process is repeated.

During the initial operation, the controller 30 checks, at predetermined intervals of time, whether the foam has reached the foam detection line SH, based on the detection signal of the photosensor 28 (Step S13). If the foam is detected at the foam detection line SH, the controller 30 stops the pump motor 12a and discontinues the power supply to the heater 16, thereby finishing the initial operation (Step S14). Then, the controller 30 determines whether the number of the “Spray and Wait Process No. 1” carried out during the initial operation is five or less (Step S15). If the number is equal to or smaller than five, the controller 30 determines that a large amount of foam is present within the wash chamber 2, which means the dishes are not badly stained (Step S16). If the number is larger than five, the controller 30 determines that a medium amount of foam is present within the wash chamber 2, which means that the dishes are moderately stained (Step S17).

In Step S18, if the “Spray and Wait Process No. 1” process has been repeated twelve times before the foam is detected at the foam detection line SH in Step S13, the controller 30 proceeds to Step S19 to discontinue the initial operation as in Step S14, and determines that there is only a small amount of foam within the wash chamber 2, or that the dishes are badly stained (Step S20).

In advance of the subsequent main operation, the controller 30 may dilute the detergent water to lower its detergent concentration according to necessity in order to carry out an appropriate washing operation depending on how much the dishes are stained, while suppressing the development of the foam during the main operation. First, the controller 30 determines the amount of water to be renewed in the wash chamber 2, or specifically the drainage time that determines the amount of water to be renewed, taking into account the amount of the foam determined, or the amount of the stains on the dishes (Step S21). For example, if there is a large amount of foam, or if the dishes are lightly stained, the drainage time is set to 60 seconds. If there is a medium amount of foam, or if the dishes are moderately stained, the drainage time is set to 30 seconds. If there is only a small amount of foam, or if the dishes are badly stained, the drainage time is set to zero, which means that no water is discharged.

During the drainage time determined as described above, the controller 30 activates the pump motor 12a as the drainage pump motor, whereby a portion of the detergent water stored in the wash chamber 2 is discharged through the drainage hose 21 to the outside. Subsequently, the controller 30 opens the feed valve 34 to supply water until the water is refilled to the normal level line NR (Step S22). In the case of the present dishwasher, if the drainage time is 60 seconds, then almost all the detergent water is discharged from the wash chamber 2 to the outside. Therefore, the water that has been refilled to the normal level line NR contains only a small amount of the detergent that remained in the wash chamber 2 after the draining operation. As a result, the detergent concentration becomes far lower than that of the original detergent water. If the drainage time is 30 seconds, about half of the detergent water stored in the wash chamber 2 is discharged to the outside. As a result, the detergent concentration of the water refilled to the normal level line NR becomes about half as high as that of the original detergent water. If there is only a small amount of foam, the drainage time is set to zero, so that neither the drainage nor the water supply is carried out.

If the drainage operation is carried out in Step S22, a portion of the discharged water flows through the branch hose 29 into the drying duct 23, where the water extinguishes the foam ascending the drying duct 23 and washes off any stain from the opposite faces of the photoemitter 281 and the photoreceiver 282 of the photosensor 28. With the draining operation, the controller 30 activates the blowing fan by driving the fan motor 221 to rotate at a predetermined speed. The fan draws the air from the inlet port into the drying duct 23, thereby generating an air stream that exerts a pressure onto the foam ascending from the outlet port 27. Even if the outlet port 27 is mostly or entirely sealed with the water stored in the wash chamber 2, the air stream can flow from the drying duct 23 into the wash chamber 2 through the air hole 261, which provides another passage between the interior of the wash chamber 2 and the interior of the drying duct 23. The water and the air, both flowing through the drying duct 23, effectively extinguish the foam present within the drying duct 23.

After the concentration of the detergent water is regulated as described previously, the main operation is started. In the main operation, the pump motor 12a is controlled so that a process called “Spray and Wait Process No. 2” is repeated several times determined according to the amount of the foam. The “Spray and Wait Process No. 2” process includes an intermittent operation having five on/off cycles conducted in the strong operation mode, followed by a 4.5 second continuous operation conducted in the weak operation mode and a 30-second intermission. Each on/off cycle includes a 0.2-second “on” period followed by a one-second “off” period.

The controller 30 determines the number of operations for the “Spray and Wait Process No. 2” process according to the amount of the foam determined previously, or according to how much the dishes are stained (Step S23). For example, the number is set to five if there is a large amount of foam (or if the dishes are lightly stained), to ten if there is a medium amount of foam (or if the dishes are moderately stained), or to fifteen if there is a small amount of foam (or if the dishes are badly stained). Subsequently, the controller 30 starts the main operation by activating the pump motor 12a as the wash pump motor and simultaneously energizing the heater 16 (Step S24).

Through the intermittent strong operation followed by the continuous weak operation, the detergent water is sprayed onto the dishes for a period of time longer than the initial operation. The detergent water evenly reaches the entire surface of the dishes and removes the stains from the dishes. Even though the detergent water is diluted according to how much the dishes are stained, the water will foam to some extent through the intermittent and continuous operations. However, the amount of the foam is not so large as in the initial operation. Even if a certain amount of foam develops, the foam dissipates through the subsequent 30-second intermission.

In Step S25, when the “Spray and Wait Process No. 2” process has been repeated the predetermined number of times, the controller 30 stops the pump motor 12a and discontinues the power supply to the heater 16, thereby finishing the main operation (Step S26).

Thus, the main operation washes the dishes according to how much they are stained, while preventing the foam from abnormally developing within the wash chamber 2. The points are as follows:

(1) The detergent water is diluted according to the amount of the foam so that the detergent concentration becomes lower as the amount of the foam becomes larger.

(2) The wash and drainage pump 12 is controlled to carry out the “Spray and Wait Process No. 2” process.

(3) The period of time for activating the wash and drainage pump 12 as the wash pump is set shorter as the amount of the foam is larger. More exactly, the number of the “Spray and Wait Process No. 2” process is reduced to shorten the total operation time.

Instead of changing the number of times for activating the wash and drainage pump 12, it is possible to vary the “on” period of the intermittent operation or the “on” period of the continuous operation in the “Spray and Wait Process No. 2” process to change the operation time of the wash and drainage pump 12. Alternatively, the pressure of the wash and drainage pump 12, or the speed of the pump motor 12a, may be changed instead of the operation time of the wash and drainage pump 12. Furthermore, it is possible to carry out a process for suppressing the development of the foam when the foam is detected at the foam detection line SH during the main operation. For example, the operation may be halted to further dilute the detergent water, or the speed of the pump motor 12a of the wash and drainage pump 12 may be reduced.

After the main operation is finished, the controller 30 activates the pump motor 12a as the drainage pump motor to discharge the water from the wash chamber 2 through the drainage hose 21 to the outside (Step S27). This is the end of the first washing operation. During this drainage operation, a portion of the water flows through the branch hose 29 into the drying duct 23 and the blowing fan is simultaneously activated, whereby the foam present within the drying duct 23 is assuredly extinguished. If the stain washed off from the dishes during the first washing operation is stuck on the opposite faces of the photoemitter 281 and the photoreceiver 282, the aforementioned water washes off the stain, thereby preventing the misdetection of the foam by the photosensor 28.

The first washing operation has a limit temperature for the detergent water to be heated. This temperature, or the “first limit temperature”, should be determined as desired within the range of lower than 52 degrees Celsius, which causes the thermocoagulation of many kinds of proteins. In this embodiment, the first limit temperature is set to 50 degrees Celsius. During the initial and main operations, the controller 30 detects the temperature of the detergent water with the temperature sensor 33. On determining that the temperature of the detergent water has reached the limit temperature of 50 degrees Celsius, the controller 30 controls the on/off action of the heater 16 to maintain the temperature. This method removes proteinaceous stains while mostly preventing the thermocoagulation. Furthermore, the relatively high temperature is effective in removing stains composed of oil and fat.

At the start of the second washing operation, the controller 30 opens the feed valve 34 to supply water into the wash chamber 2 up to the normal level line NR (Step S31). After the water supply is finished, the detergent water stored in the wash chamber 2 has a very low detergent concentration, which contains only a small amount of the detergent remaining after the water used in the first washing operation is drained.

Subsequently, the controller 30 activates the pump motor 12a as the wash pump motor to draw water from the reservoir 8 and thrust the water toward the wash arm 6 to spray it from the nozzles 7 onto the dishes. The speed of the pump motor 12a is set to the value for the weak operation mode: 2300 r.p.m. At the same time, the controller 30. starts energizing the heater 16 to heat the detergent water stored in the wash chamber 2 (Step S32).

Using the temperature sensor 33, the controller 30 repeatedly detects the temperature of the water stored in the wash chamber 2 to check whether the water temperature has reached 40 degrees Celsius (Step S33). If the water temperature has reached 40 degrees Celsius, the controller 30 switches the pump motor 12a from the weak operation mode to the strong operation mode, in which the speed is set to 2700 r.p.m. (Step S34). After maintaining the strong operation mode for one minute (Step S35), the controller 30 switches the pump motor 12a from the strong operation mode to the weak operation mode (Step S36). During the one-minute strong operation, the heater 16 keeps heating the water, so that the water temperature gradually rises. In this one-minute strong operation, the rise in the speed of the pump motor 12a increases the power of the water sprayed from the nozzles 7. Therefore, the water can completely remove any proteinaceous stain that may remain even after the first washing operation.

Next, the controller 30 repeatedly checks whether the temperature detected with the temperature sensor 33 has reached the second limit temperature (Step S37). In the present embodiment, the second limit temperature is 50 degrees Celsius, which equals the first limit temperature. When the washing performance is solely concerned, the second limit temperature should be set higher. However, in the present case, the temperature is set to 50 degrees Celsius for the reason explained later.

In Step S37, when the water temperature reaches 50 degrees Celsius, the controller 30 controls the on/off action of the heater 16 to maintain the temperature (Step S38), and also restores the speed of the pump motor 12a from the weak operation mode to the strong operation mode (Step S39). After maintaining the strong operation mode for one minute (Step S40), the controller 30 switches the motor from the strong operation mode to the weak operation mode (Step S41). The weak operation is maintained for three minutes (Step S42). After the three minutes, the controller 30 switches the motor from the weak operation mode to the strong operation mode (Step S43), and maintains the strong operation mode for one minute (Step S44). Powerfully spraying warm water having a temperature of 50 degrees Celsius onto the dishes has the effect of separating stains composed of starch, oil or fat from the dishes and washing off the stains.

In Step 44, when the one-minute period has lapsed, the controller 30 stops the pump motor 12a and discontinues the heating operation with the heater 16 (Step S45). Subsequently, it activates the pump motor 12a as the drainage pump motor to discharge the water from the wash chamber 2 through the drainage hose 21 to the outside (Step S46). Again in this process, a portion of the water flows through the branch hose 29 back into the drying duct 23 and is poured onto the photosensor 28 to clean it.

As opposed to the intermittent operation of the first washing operation, the second washing operation is a continuous process, so that the water spray has a much higher average strength. This strong water spray enables the second washing operation to adequately wash off the stains composed of starch, oil or fat that are hardly removed in the first washing operation. In the second washing operation, the concentration of the detergent water is very low, so that the abnormal development of the foam never occurs. Therefore, there is no need to perform the “spray and wait” process as in the first washing operation.

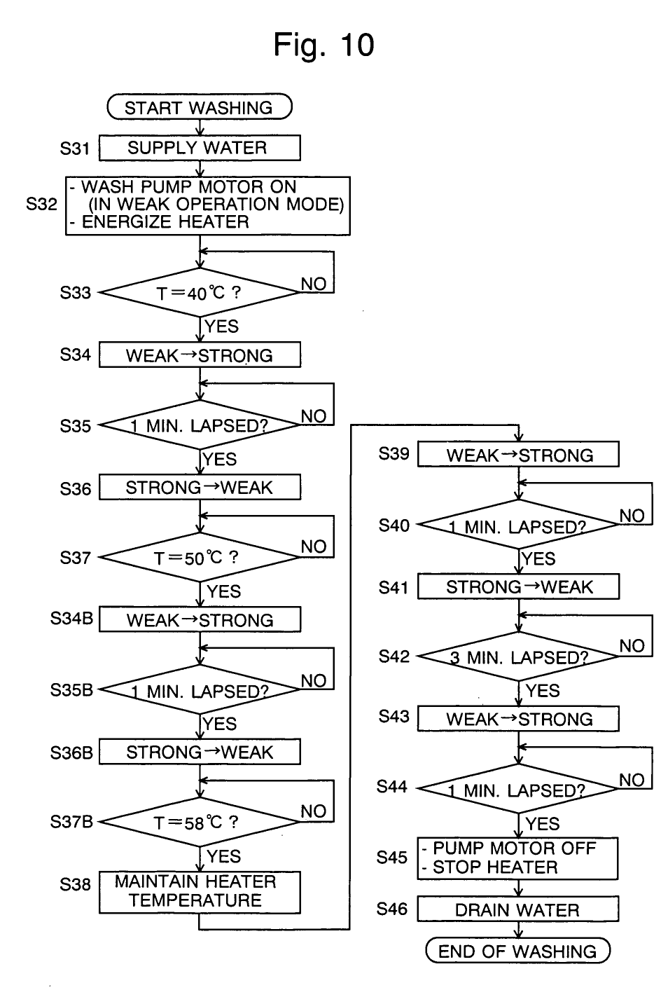

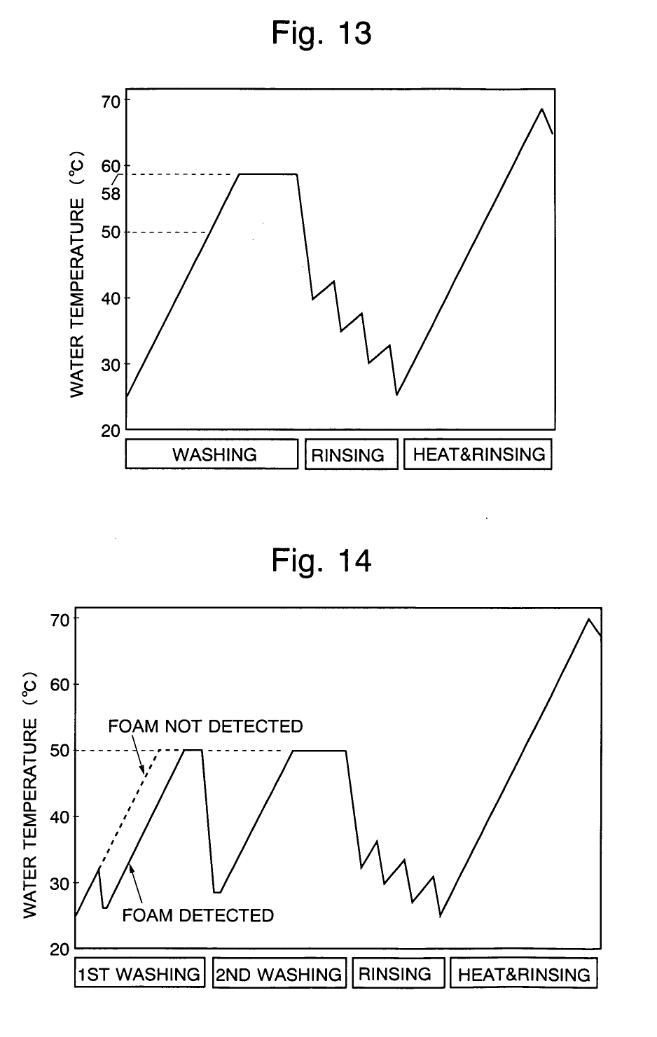

The normal washing process using a dedicated detergent is described in detail. FIG. 10 is a detailed flowchart of the washing operation (i.e. Step S1, described previously), and FIG. 13 is a graph roughly showing the temperature of the water changing with the progress of the process.

The control steps of the present washing operation are quite similar to those of the second washing operation of the kitchen detergent course (see FIG. 12). Accordingly, the identical steps are given the same step numbers. As clearly understood from the temperature change shown in FIG. 13, the differences are as follows: (1) The upper limit temperature for heating the detergent water is 58 degrees Celsius, which is higher than 50 degrees Celsius; (2) In Steps S34B-S37B, which are similar to Step S34-S37, the one-minute strong operation and the subsequent weak operation are carried out after the water temperature reaches 50 degrees Celsius until it reaches 58 degrees Celsius.

Many kinds of proteins contained in eggs or other foods have thermocoagulation temperatures of higher than 52 degrees Celsius. In contrast, the protease contained in detergents dedicated to dishwashers becomes most activated and exhibits high capability at about 50 degrees Celsius. Therefore, in Step S34B, the dishes are washed with a strong spray of water having a temperature of 50 degrees Celsius. This method enables the protease to fully act on most kinds of proteins that are not thermocoagulated. Thus, it is now possible to remove the proteinaceous stains that the previous strong operation (Step S34) could not remove. In another aspect, most animal oils and fats, which usually take solid forms at room temperatures, are liquefied at about 50 degrees Celsius and easy to wash. For example, the melting point of beef tallow is from 35 to 55 degrees Celsius, and that of lard is from 28 to 48 degrees Celsius. Therefore, the washing operation will expectedly have the effect of washing off stains composed of animal oils and fats by switching to the strong operation mode when the water temperature has reached 50 degrees Celsius.

In general, a dedicated detergent contains an amylolytic enzyme in addition to the protease. An amylolytic enzyme usually becomes most activated and exhibits high capability at about 58 degrees Celsius, a temperature higher than that for protease. Also, most of dedicated detergents are powdery and more soluble into water having a higher temperature, and the temperature of 58 degrees Celsius is high enough for such detergents to adequately dissolve into water, so that non-enzyme washing components can exhibit good washing effects. Therefore, powerfully spraying warm water having a temperature of 58 degrees Celsius onto the dishes has the effect of separating stains composed of starch, oil or fat from the dishes and washing off the stains.

In the operation course assuming the use of a dedicated detergent, even if the water is strongly sprayed, a large amount of foam never develops under normal conditions as long as a proper amount of detergent is used. Therefore, the average strength of the water spray throughout the washing operation (which includes the first and second washing operations in the case of the kitchen detergent course), or the speed of the pump motor 12a, is set higher than that in the kitchen detergent course. This setting leads to a higher level of washing performance. On the other hand, the kitchen detergent course suppresses the development of a large amount of foam by setting the average strength of the water spray throughout the washing operation lower than that in the operation course using a dedicated detergent.

To compensate for the decrease of the washing performance due to the average weakness of the water spray, the total operation time of the kitchen detergent course is set longer than that of the operation course using a dedicated detergent. This setting provides a longer period of time for the dishes to be wet with the detergent water (or receive the sprayed detergent water), thereby enabling the detergent to effectively act on the stains and help the separation of the stains so that an adequate level of washing performance is obtained. However, extending the period of time for the washing operation leads to an increase in the electric power consumed by the heater 16 because the time for heating the water becomes accordingly longer. Taking this into account, in the present embodiment, the second upper limit temperature is set to 50 degrees Celsius, lower than 58 degrees Celsius in the kitchen detergent course, to suppress the power consumption of the heater 16.

As described above, the dishwasher in the present embodiment has two different operation courses: one for the use of a dedicated detergent, and the other for the use of a common kitchen detergent, and users select one of the two courses in advance through a key operation on the operation unit 18a. In other words, the user should manually select either the dedicated detergent operation sequence or the kitchen detergent operation sequence. If the operation course selected matches the type of the detergent used, the operation progresses as desired. However, if the operation course selected does not match the type of the detergent used, some problems will arise.

Specifically, if a user selects the normal operation course (not the kitchen detergent course) and puts a kitchen detergent into the dishwasher, an abnormal amount of foam will develop within the wash chamber 2 immediately after the water spray is started during the washing operation. Taking this into account, the normal operation course assuming the use of a dedicated detergent repeats a foam-detection process throughout the washing operation, as shown in FIG. 16.

In the washing operation, after activating the pump motor 12a as the wash pump motor, the controller 30 checks whether the detection output of the photosensor 28 has dropped by an amount equal to or larger than a predetermined value (Step S51). If no such drop is detected, the controller 30 determines that there is (precisely, has yet been) no abnormal development of foam, and continues the operation (Step S52). If the aforementioned drop of the detection output has been detected in Step S51, the controller 30 determines that an abnormal amount of foam has developed, and temporarily halts the operation to carry out a defoaming process (Steps S53 and S54).

In the present embodiment, two methods are combined as the defoaming process. In the first method, which was described earlier, the wash and drainage pump 12 is activated as the drainage pump to discharge a predetermined amount of the detergent water from the wash chamber 2 to the outside. Subsequently, the feed valve 34 is opened to refill the water up to the normal level line NR to lower the concentration of the detergent water stored in the wash chamber 2. As explained previously, a portion of the water discharged into the drainage hose 21 is returned to the drying duct 23, and the returned water is poured onto the foam ascending the drying duct 23 to push the foam back into the wash chamber 2. Thus, the water extinguishes the foam ascending and filling the drying duct 23.

At the same time, the controller 30 activates the blowing fan by driving the fan motor 221 to rotate at a predetermined speed. The fan draws the air from the inlet port into the drying duct 23, thereby generating an air stream that exerts a pressure onto the foam ascending from the outlet port 27. During this process, the outlet port 27 may be mostly or entirely sealed with the water stored in the wash chamber 2. However, the air stream can flow from the drying duct 23 into the wash chamber 2 through the air hole 261, which provides another passage between the interior of the wash chamber 2 and the interior of the drying duct 23. Thus, the air stream is assuredly generated within the drying duct 23, whereby the ascending foam is pushed back toward the outlet port 27.

After the defoaming process is performed, or while such a process is being performed, the controller 30 checks the detection output of the photosensor 28 again to determine whether the defoaming process has made the detection output recovered from the dropped state (Step S55). If it has recovered, the controller 30 determines that the foam has subsided and the concentration of the detergent water is now adequately low. Accordingly, it resumes the operation by activating the wash and drainage pump 12 as the wash pump to spray the detergent water from the nozzle 7 onto the dishes (Step S56). In this case, the controller 30 displays an alarm message, activates an alarm buzzer or takes some other action to inform the user of the occurrence of the abnormal development of the foam (Step S57).

Thus, if an abnormal amount of foam has developed during the washing operation, the present dishwasher not only extinguishes the foam produced but also suppresses the redevelopment of the foam through the subsequent washing phases by lowering the concentration of the detergent water. Therefore, the operation can be carried out to the end as scheduled. The audio or visual information about the abnormal development of the foam enables the user to know that he or she has used a wrong type of detergent or an excessive amount of the dedicated detergent.

The first rinsing operation, which follows the washing operation, is accompanied by the possibility that an abnormal amount of foam results from the action of an amount of detergent remaining in the wash chamber 2 after the water used in the washing operation is drained. Therefore, the above-described process may be also carried out during the rinsing operation (particularly the first rinsing operation) in addition to the washing operation.

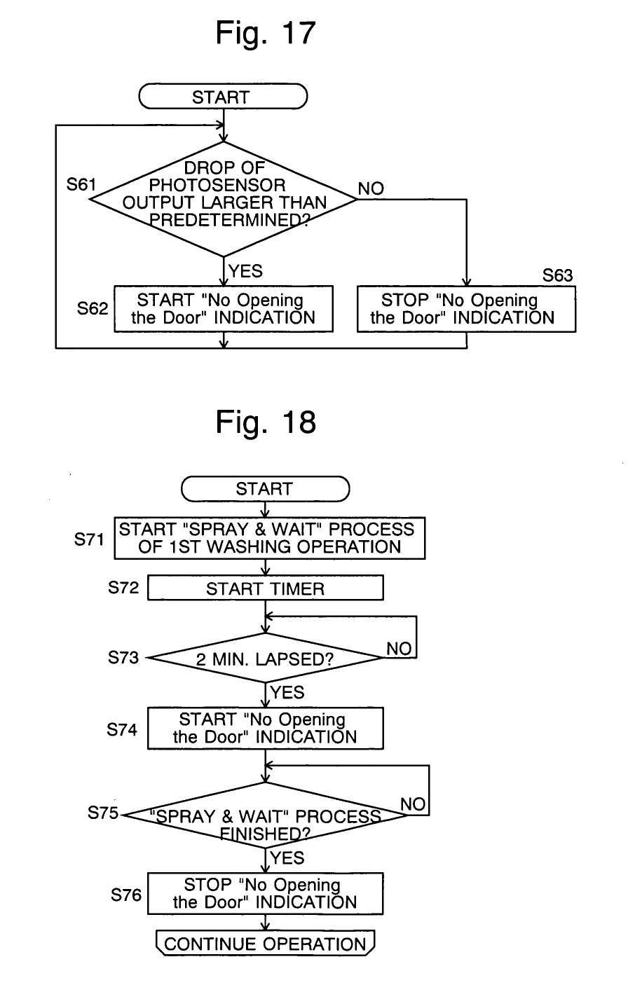

The present dishwasher allows the user to open the doors 3 and 4 by holding the handle 17 and releasing the latch even during the washing or rinsing operation. When the doors 3 and 4 are opened, the wash and drainage pump 12 is temporarily halted to prevent the water sprayed from the nozzles 7 from sprinkling out through the front opening. However, if the doors 3 and 4 are opened with an abnormal amount of foam present within the wash chamber 2, the foam may flow out of the front opening. To avoid this situation, the displaying process shown in the control flowchart of FIG. 17 is repeatedly carried out during the period from the start of the washing operation to the end of the heating and rinsing operation.

In the process, the controller 30 repeatedly checks whether the detection output of the photosensor 28 has dropped by an amount equal to or larger than a predetermined value (Step S61). This predetermined value may be the same as or different from the value used in the process of checking the drop of the detection output of the photosensor 28 to carry out the defoaming process described with reference to FIG. 16. If the detection output has dropped by an amount equal to or larger than the predetermined value, the controller 30 determines that the foam will possibly flow out if the doors 3 and 4 are opened, and displays a “No Opening the Door” indication, an indication cautioning users against opening the doors, on the display unit 18b (Step S62). A buzzer may be used instead of the visual indication. However, the visual indication is more preferable because the buzzing sound may be frequently produced.

After the “No Opening the Door” indication has been displayed, if the detection output of the photosensor 28 has recovered, the controller 30 determines that there is no possibility that the foam will flow out when the doors 3 and 4 are opened, so that it turns off the “No Opening the Door” indication on the display unit 1 8b (Step S63). In the present case, the “No Opening the Door” indication is based on the possibility that the foam may flow out. Furthermore, the “No Opening the Door” indication may also take into account another determination result based on a different factor, such as the possibility that the water sprayed from the nozzle 7 may be scattered to the outside.

In the above example, the “No Opening the Door” instruction is issued when an abnormal amount of foam is present. It is also possible to issue such an instruction during a period of time in which an abnormal amount of foam develops with a highly probability, irrespective of whether such an amount of foam is actually present. FIG. 18 is a control flowchart showing an example.

According to this control, when the “spray and wait” process begins in the first washing operation (Step S71), the controller 30 starts a timer to measure the lapse time (Step S72), and when two minutes has lapsed, it displays the “No Opening the Door” indication (Steps S73 and S74). The indication is withheld until the lapse of two minutes for the following reasons: (1) During the initial period of about two minutes, the water rarely foams because the temperature is low. (2) In the initial stage of the operation, users often want to open the door to set additional dishes or do some other work. After detecting the lapse of two minutes from and displaying the “No Opening the Door” indication, the controller 30 repeatedly checks whether the first washing operation is finished. When it is finished, the controller 30 determines that there is no possibility that the foam flows out when the doors 3 and 4 are opened, so that it turns off the “No Opening the Door” indication on the display unit 18b (Steps S75 and S76).

Some users pay little attention to such warning information and may attempt to open the doors 3 and 4. Taking this into account, it is preferable to use a door-locking mechanism for preventing the doors 3 and 4 from opening, or for preventing the latch of the doors 3 and 4 from being released, to more assuredly prevent the foam from flowing to the outside. During the operation, the doors 3 and 4 are locked so that the user cannot immediately open them. Usually, upon a predetermined operation, such as the pausing operation, the lock is released to allow the doors 3 and 4 to be opened. In contrast, when an abnormal amount of foam is detected within the wash chamber 2 as described above, the aforementioned predetermined operation does not unlock the doors; this time, unlocking the doors requires a special key operation, such as a simultaneous press of two or more operation keys that are not usually combined. Thus, the doors 3 and 4 are prevented from easily opening if it is highly probable that the foam will escape to the outside.

In the above description, the user manually selects one of the two operation courses each of which assumes the use of either a dedicated detergent or a kitchen detergent. It is also possible to add an automatic detergent-identifying function that automatically switches the operation to a course matching the actual detergent type to carry out an appropriate washing operation according to the amount of the foam produced and the amount of the stains on the dishes if the manually selected course does not match the detergent type.

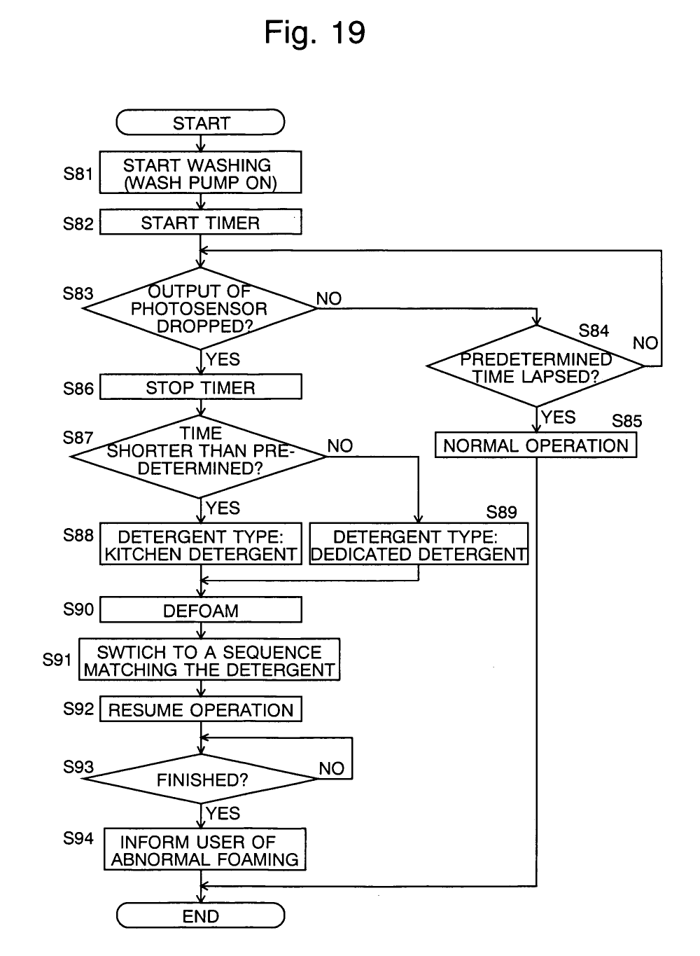

FIG. 19 is a control flowchart of the main section of a dishwasher having an automatic detergent-identifying function. According to the operational sequence assuming the use of a dedicated detergent, the controller 30 activates the wash and drainage pump 12 as the wash pump to start the washing operation (Step S81), and then starts a timer to measure the lapse time (Step S82). Subsequently, the controller 30 checks whether the detection output of the photosensor 28 has dropped by an amount equal to or larger than a predetermined value, i.e. whether the foam has reached the foam detection line SH (Step S83). If no such drop of the detection output of the photosensor 28 is found, the controller 30 checks whether a predetermined period of time has lapsed since the start of the timer (Step S84), and returns to Step S83 until the specified period of time lapses. If the specified period of time has lapsed without the aforementioned drop of the detection output of the photosensor 28, the controller 30 continues the normal operation, determining that a dedicated detergent has been put into the dishwasher by an amount equal to or smaller than a specified value (Step S85).

If the drop of the detection output of the photosensor 28 has occurred before the lapse of the specified period of time, the timer is immediately stopped (Step S86). The period of time from the activation of the wash pump to the drop of the detection output of the photosensor 28 becomes shorter as the detergent put in the wash chamber 2 is easier to foam. Accordingly, the controller 30 checks whether the time measured with the timer is equal to or shorter than a predetermined value (Step S87). If the time is equal to or shorter than the predetermined value, the controller 30 determines that the detergent used is a kitchen detergent that easily foams, whereas, if the time is longer than the predetermined value, the controller 30 determines that the detergent used is a dedicated detergent that hardly foams (Steps S88 and S89). The latter case leads to the conclusion that the detergent is the dedicated type but the amount used is too large, because a dedicated detergent usually foams little if it is used by a proper amount.

In any of Steps S88 and S89, the foam is already present at the foam detection line SH in the drying duct 23, so that the controller 30 carries out the defoaming process described earlier to extinguish the foam in the drying duct 23 (Step S90). After that, the controller 30 changes the operational sequence to the one matching the detergent type identified (i.e. either a dedicated or kitchen detergent), if it is necessary (Step S91). In the case of the kitchen detergent, the operational sequence should be changed to the one corresponding to the kitchen detergent course. In the case of the dedicated detergent, the current operational sequence may be maintained, or a process of draining and refilling a small amount of water to lower the concentration of the detergent water may be carried out before the previous operational sequence (i.e. the sequence adapted for dedicated detergents) is resumed.

Next, the controller 30 resumes the operation according to the newly selected (or previously selected) operational sequence (Step S92). Changing the operational sequence or lowering the concentration of the detergent water in Step S91 prevents the foam from abnormally developing again after the resumption of the operation. After continuing the operation and finishing all the necessary processes (“Yes” in Step S93), the controller 30 informs the user of the abnormal development of the foam, using the display unit 1 8b or the buzzer (Step S94).

According to the above-described process, if a kitchen detergent is mistakenly used instead of a dedicated detergent, or if the dedicated detergent is used by an excessive amount, the controller 30 identifies the detergent type on the basis of how it foams, and changes the operational sequence to suppress the foaming, if it is necessary. The operation is finished to the end, and the user is informed of the abnormal development of the foam, if any, for the first time after the end of the operation. Therefore, even if an abnormal development of the foam occurs, the operation never stops halfway through. Also, being informed of any abnormal development of the foam, the user has a chance to know that the type or amount of the detergent he or she used was incorrect.

In FIG. 19, the defoaming process and the change of the operational sequence are performed after the detergent is identified. Alternatively, it is possible to discharge a predetermined amount of the detergent water from the wash chamber 2 to the outside and then refill the water to the normal level line NR to lower the concentration of the detergent water without changing the operational sequence. In this case, it is preferable to regulate the concentration of the detergent water stored in the wash chamber 2 by changing the period of time for draining the water according to the detergent type. Furthermore, it is possible to evaluate the amount of the kitchen detergent used or the state of the stains on the dishes by a closer examination of the time measured with the timer, and determine the drainage time according to the evaluation.

As explained previously, the photosensor 28 of the present dishwasher can be used for the detection of water level as well as for the detection of the foam. The foam detection line SH is located only slightly lower than the overflow line OF. Therefore, a water level that is detectable with the photosensor 28 should be regarded as an abnormally high level at which the water is about to spill out from the front opening of the wash chamber 2. The present dishwasher has the level sensor 19 used for checking whether the water in the wash chamber 2 has reached an abnormal level located at a level lower than the overflow line OF. Therefore, if the water is detected with the photosensor 28, it is probable that the level sensor 19 is not working, i.e. that it is broken. Even in such a situation, the present dishwasher can prevent the overflow of the water.

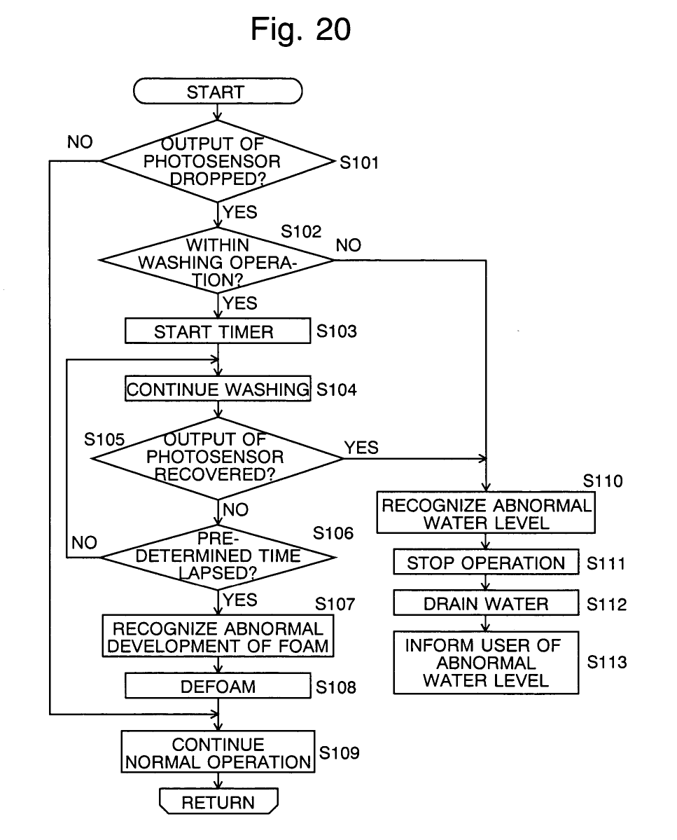

The detection output of the photosensor 28 is commonly used in both the foam detection and the water level detection. Therefore, it is necessary to determine the type of abnormal situation implied by the output. For this purpose, upon a drop of the detection output of the photosensor 28, the process shown in FIG. 20 is carried out to determine the type of the abnormal situation and take appropriate measures for it.

If the detection output of the photosensor 28 has dropped to a predetermined value or lower (“Yes” in Step S101), the controller 30 checks whether the process is within the washing operation at the moment (Step S102). If not within the washing operation, the drop of the detection output is not attributable to the foam caused by an agitation of detergent water. Therefore, the controller 30 concludes that it is due to an abnormal rise in the water level and discontinues the operation (Steps S110 and S111). Subsequently, it activates the wash and drainage pump 12 as the drainage pump to discharge the water from the wash chamber 2, and informs the user of the abnormal water level, using a buzzer or another informing device (Steps S112 and S113). Thus, the water is prevented from overflowing through the gap between the door 4 and the front opening of the wash chamber 2 or through other apertures.

In Step S102, if it is determined that the process is within the washing operation, the situation is attributable to either the foaming or the rise of the water level. Accordingly, the controller 30 starts the timer and continues the washing operation (Steps S103 and S104), while checking whether the detection output of the photosensor 28 has recovered from the dropped state (Step S105). If the detection output is still in the dropped state, the controller 30 checks whether a predetermined period of time (e.g. a few seconds) has lapsed since the start of the timer (Step S106). If the aforementioned period of time has not lapsed yet, the process returns to Step S104.

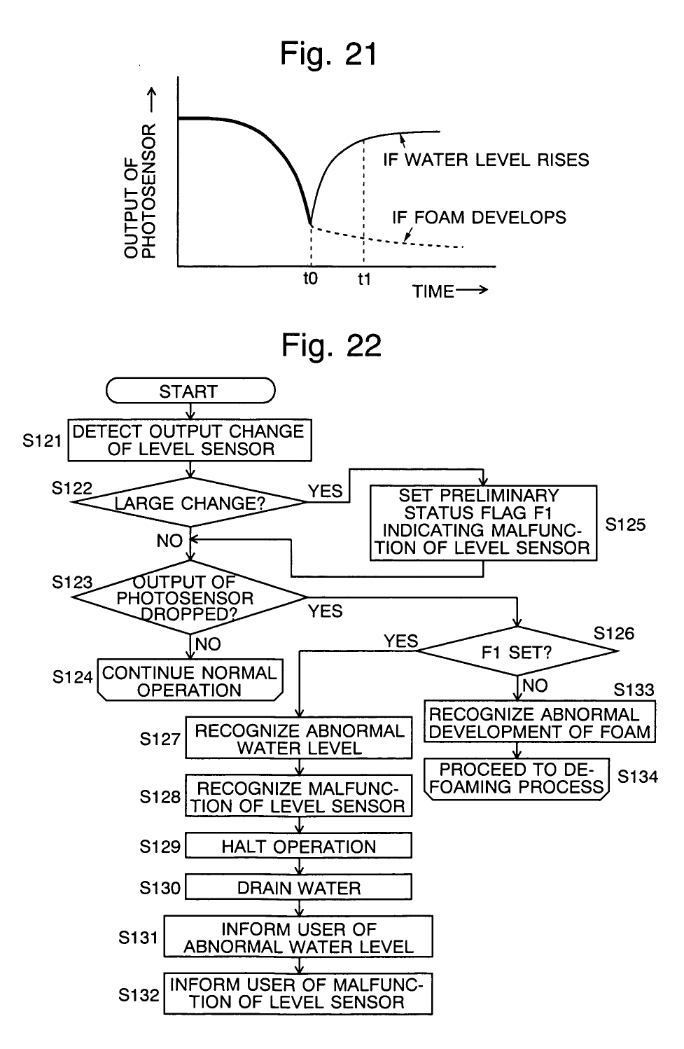

FIG. 21 is a graph showing the temporal change of the detection output of the photosensor 28. As explained above, in the case where the drop of the detection output of the photosensor 28 is due to an abnormal development of the foam, the detection output may further drop with time but will rarely recover from the dropped state. In contrast, in the case where the drop of the detection output of the photosensor 28 is due to a rise of the water level, an additional rise of the water level with time will create a situation where the light emitted from the photoemitter 281 travels through the water and reaches the photoreceiver 282, so that the detection output of the photosensor 28 rapidly recovers, as shown in FIG. 21.

Accordingly, if the detection output of the photosensor 28 has recovered within the predetermined period of time (t1-t0 in FIG. 21) from the point in time (t0) at which the detection output dropped by an amount equal to or larger than the predetermined value, the process proceeds through Step S105 to Step S110. In contrast, if the detection output of the photosensor 28 has not recovered within the predetermined period of time (t1-t0) from the drop of the detection output, the process proceeds through Step S106 to Step S107. Setting the period of time (t1-t0) longer enables a more reliable distinction between the foam and the water level. However, it also increases the possibility that the water comes closer to or exceeds the overflow line OF and finally overflows. Taking this problem into account, the period of time (t1-t0) should be appropriately determined with respect to the speed at which the water level is expected to rise.

If the process reaches Step S107, the controller 30, determining that an abnormal amount of foam has developed, carries out the defoaming process described earlier and continues the operation (Steps S108 and S109). If the process reaches Step S110, the operation proceeds through Steps S111 to S113 as described previously. Thus, both the abnormal development of the foam and the abnormal rise of the water level are correctly detected from the detection output of the single photosensor 28 consisting of the photoemitter 281 and the photoreceiver 282.

In the above description, if the detection output of the photosensor 28 drops during the washing operation, whether the output drop is due to the development of the foam or the rise of the water level is identified on the basis of the temporal change of the detection output. Alternatively, a different identifying method may be used. An example is shown in the control flowchart of FIG. 22.

The controller 30 detects the change of the output of the level sensor 19 (Step S121). If the level sensor 19 is out of order, the output is liable to fluctuate in an unstable manner. Accordingly, if the change of the output is equal to or larger than a predetermined value (“Yes” in Step S122), the controller 30 determines that the level sensor 19 should be out of order, and sets a preliminary status flag F1, which indicates the malfunction of the level sensor 19 (Step S125). The processes of Steps S121, S122 and S125 may be carried out at a proper time, e.g. when the dishwasher is energized, or when the dishwasher is idling with the power supply on.

During the washing operation, and during other operation, the controller 30 checks whether the detection output of the photosensor 28 has dropped by an amount equal to or larger than a predetermined value (Step S123). If no such drop of the detection output is detected, the operation is continued as usual (Step S124). In contrast, if the drop of the detection output of the photosensor 28 has been detected, the controller 30 checks whether the preliminary status flag F1 is “on” (Step S126). If it is “on”, the controller 30 concludes that the output drop of the photosensor 28 is due to an abnormal water level and, moreover, the level sensor 19 is out of order (Steps S127 and S128).

In such a case, the controller 30 stops the operation and activates the wash and drainage pump 12 as the drainage pump to discharge the water from the wash chamber 2 (Steps S129 and S130). Furthermore, it informs the user of the abnormal water level, using a buzzer or another informing device, and of the malfunction of the level sensor 19 by an indication on the display unit 18b or in a similar manner (Steps S131 and S132). Thus, the water is prevented from overflowing through the gap between the door 4 and the front opening of the wash chamber 2 or through other apertures, and the user is informed of the occurrence of the malfunction of the level sensor 19.

In Step S126, if the preliminary status flag F1 is “off”, the level sensor 19 is correctly working, so that the drop of the detection output of the photosensor 28 is not attributable to a rise of the water level. Therefore, the controller 30 concludes that the output drop is due to an abnormal development of the foam (Step S133), and proceeds to the defoaming process described earlier (Step S134). Thus, using the detection output of the photosensor 28, it is possible to detect both the malfunction of the level sensor 19 and the abnormal water level caused thereby.

In the above-described embodiment, the dishwasher uses both the pressure-sensitive level sensor 19 capable of detecting water at multiple levels and the photosensor 28 in order to detect the abnormal water level in the wash chamber 2. Alternatively, it is possible to use only the detection output of the photosensor 28 to detect the abnormal water level and employ a simple-structured level switch to detect the normal level line NR for the normal washing operation. In many cases, simple-structured level switches are less expensive than the aforementioned level sensor 19.

In the above-described embodiment, the branch hose 29 for introducing water into the drying duct 23 diverges from the drainage hose 21. Alternatively, the branch hose 29 may be constructed to diverge from a double-port valve employed as the feed valve 34 constituting the water supply means, or from the supply pipe connecting the feed valve 34 and the wash chamber 2. In this construction, every time the feed valve 34 is opened to supply water into the wash chamber 2, a portion of the water flows through the branch hose 29 into the drying duct 23, where the water not only extinguishes any foam present within the drying duct 23 but also washes off any stain from the photosensor 28, as explained previously.

It should be noted that the above-described embodiment is a mere example of the present invention. Apart from the points mentioned above, the embodiment may be further changed, modified or extended within the spirit and scope of the present invention.

1. A dishwasher having a wash chamber for containing dishes and/or utensils and a washing means for drawing water from a bottom of the wash chamber and for spraying the water onto the dishes and/or utensils, which is characterized by:
a detergent selector for determining whether a detergent used is a dishwasher-dedicated detergent or a common kitchen detergent and for setting a detergent type, or for allowing users to externally set the detergent type, before a start of or in an initial phase of an operation; and
an operation controller for selectively carrying out one of the following operational sequences according to the detergent type set by the detergent selector: a dedicated operational sequence in which a washing operation is adapted for washing the dishes and/or utensils with a dishwasher-dedicated detergent; and a normal operational sequence in which the washing operation is adapted for washing the dishes and/or utensils with a common kitchen detergent.

2. The dishwasher according to claim 1, characterized in that the operation controller controls the washing means so that an average strength of the sprayed water is lower in the normal operational sequence than that in the dedicated operational sequence.

3. The dishwasher according to claim 2, characterized in that the operation controller is constructed so that a total period of time for the washing operation using the detergent water is longer in the case of the normal operational sequence than that in the case of the dedicated operational sequence.

4. The dishwasher according to claim 3, characterized in that it further includes a heating means for heating the water stored in the bottom of the wash chamber, and the operation controller controls the heating means so that a heating temperature for the detergent water is set lower in the case of the normal operational sequence than in the case of the dedicated operational sequence.

5. The dishwasher according to claim 1, characterized in that the normal operational sequence includes the following two operations:
a first washing operation in which an average strength of the water sprayed from the washing means is relatively lower; and
a second washing operation having the steps of draining the detergent water used in the first washing operation, introducing fresh water into the wash chamber, and washing the dishes and/or utensils with a residual detergent, where the average strength of the water spray is set higher than that of the first washing operation.

6. The dishwasher according to claim 1, characterized in that it includes a foam detector for detecting a state of foam developed within the wash chamber, and the operation controller conducts the washing operation according to an operational sequence corresponding to the state of the foam detected with the foam detector when the washing means is energized with the detergent water stored in the wash chamber.

7. The dishwasher according to claim 6, characterized in that the operation controller continues the washing operation through a predetermined final phase even if an abnormal development of foam is detected with the foam detector, and then informs a user of an occurrence of the abnormal development of the foam with an annunciator at an end of the operation.

8. The dishwasher according to claim 6, characterized in that the foam detector includes:
a photosensor having a photoemitter and a photoreceiver facing each other across a space leading to an interior of the wash chamber, where the space is out of a direct reach of the water sprayed from the washing means; and
a determining means for examining an output of the photoreceiver of the photosensor to determine whether an abnormal amount of foam is present or not.

9. The dishwasher according to claim 8, characterized in that the photosensor is located within a drying duct connected to a lower section of the wash chamber to supply a drying wind into the wash chamber.

10. The dishwasher according to claim 8, characterized in that the photoemitter and the photoreceiver of the photosensor are located so that: light emitted from the photoemitter to the photoreceiver travels along a path inclined to a horizontal surface; and the foam detector is also capable of detecting a water level in the wash chamber.

11. The dishwasher according to claim 10, characterized in that a drop of the output of the photoreceiver makes the determining means monitor the output of the photoreceiver continuously for a predetermined period of time, or intermittently a plurality of times, to determine whether the drop is due to a development of the foam or a rise of the water level.

12. The dishwasher according to claim 10, characterized in that it further includes a level detector for detecting the level of the water stored in the wash chamber, and the foam detector is used to detect the water level only when the level detector is assumed malfunctioning.

13. The dishwasher according to claim 10, characterized in that it further includes a level detector for detecting the level of the water stored in the wash chamber, and the level detector is used to detect the level of the water stored for the washing or rinsing operation, while the foam detector is used to detect an abnormal water level.

14. The dishwasher according to claim 8, characterized in that it further includes:
a drying duct connected to a lower section of the wash chamber to supply a drying wind into the wash chamber, with the photoemitter and the photoreceiver of the photosensor being located within the drying duct, facing each other;
a drainage pipe through which the water stored in the bottom of the wash chamber is drained to an outside;
a water supplier for supplying water from the outside into the wash chamber; and
a branch pipe having one end connected to the drainage pipe or the water supplier and the other end opened to an interior of the drying duct so that a portion of the water drained through the drainage pipe, or a portion of the water supplied through the water supplier, is poured onto the photosensor.

15. The dishwasher according to claim 14, characterized in that it further includes a water guide in the drying duct for guiding the water from the end of the branch pipe opened to the interior of the drying duct to the photoemitter and the photoreceiver of the photosensor.

16. The dishwasher according to claim 1, characterized in that it further includes:
a water supplier for supplying water from an outside into the wash chamber;
a drainage means for draining the water from the bottom of the wash chamber into a drainage pipe leading to the outside;
a drying duct connected to a lower section of the wash chamber to supply a drying wind into the wash chamber; and
a branch pipe having one end connected the drainage pipe or the water supplier and the other end opened to the interior of the drying duct so that the drying duct is flushed with a portion of the water drained through the drainage pipe or a portion of the water supplied through the water supplier.

17. The dishwasher according to claim 1, characterized in that it further includes:
a drying duct connected to a lower section of the wash chamber to supply a drying wind into the wash chamber;
a blower having a fan for drawing air from an outside and sending it through the drying duct into the wash chamber; and
a controller for driving the fan to thrust the foam from the drying duct back into the wash chamber if an abnormal amount of foam is detected during the washing or rinsing operation, or if an abnormal amount of foam is likely to develop.

18. The dishwasher according to claim 17, characterized in that a communicating element for enabling an interior of the drying duct to communicate with an interior of the wash chamber is provided at a position that is higher than a normal level of the stored water and is a lowest possible level within the drying duct.

19. The dishwasher according to claim 1, characterized in that it further includes:
a door for closing a front opening of the wash chamber; and
an annunciator for cautioning a user against opening the door during one or more specific steps of the normal operational sequence, or during one or more predetermined periods within time of such specific steps, assuming that an abnormal amount of foam is present within the wash chamber.

20. The dishwasher according to claim 1, characterized in that it further includes:
a door for closing a front opening of the wash chamber; and
a door-locking means for preventing a user from opening the door during one or more specific steps of the normal operational sequence, or during one or more predetermined periods of time within such specific steps, assuming that an abnormal amount of foam is present within the wash chamber.
